(19) United States
(12) Patent Application Publication
(10) Pub. No.: US 2002/0051958 A1
(43) Pub. Date: May 2, 2002

(54) Balanced group thinking

(76) Inventor: Darshan Singh Khalsa, Phoenix, AZ (US)

Correspondence Address: Darshan Singh Khalsa, 2245 North 8th Street, Phoenix, AZ, 85006-1609, US

(21) Appl. No.: 09/860,785

(22) Filed: May 18, 2001

Related U.S. Application Data
(60) Provisional application No. 60/209,071, filed on Jun. 2, 2000.

(51) Int. Cl. G09B 19/00

(52) U.S. Cl. 434/238

(57) ABSTRACT

A series of yoga exercises to adjust brain functioning and a storyboarding process are used as tools in creative thinking sessions. When groups of people are assembled to execute a creative organizational planning session, some of the primary impedances to effective collaboration and decision making are participants' tensions, hidden conflicts, departmental rivalries, physical fatigue and mental distractions. Yoga exercise improves physical well being, relieves stress, energizes and calms the nervous system, increases mental focus, and balances the hemispheres of the brain for better decision making. Yoga exercise combined with storyboarding provides a method for improving group collaboration, communication and decision making.

### STATEMENT REGARDING FEDERALLY SPONSORED RESEARCH OR DEVELOPMENT

Not applicable.

### BACKGROUND

1. Field of Invention

This invention relates to group decision making processes through group creative thinking sessions, facilitated group interaction and communication, collaboration, education and team building utilizing yoga exercise, storyboarding techniques and, in the preferred embodiment, a computerized Internet videoconferencing system, and more particularly, to a method for enabling groups of people to make more effective collective decisions.

2. Discussion of Prior Art

The present invention is a novel business process that combines prior art from different fields in a way not previously conceived to improve group decision making. The present invention is a combination of yoga including meditation, as the most ancient science known to mankind, combined with storyboarding, as the most creative business planning process of the 20^{th} Century, and combined with, in the invention's preferred embodiment, computer-based Internet videoconferencing and group collaboration systems.

There are no prior patents for yoga plus storyboarding, nor for yoga plus storyboarding and computer-based group collaboration. A search of the literature of these fields shows there are numerous scientific medical studies establishing the efficacious effects of yoga exercise upon the central nervous system and brain. However, there are no scientific studies or prior art documents regarding the application of yoga techniques to the business environment to improve productivity or decision making.

There are also numerous prior patents for display and facilitation of group interaction sessions, as well as for computer-based group collaboration systems and for depicting the human electromagnetic field, but none of these involve yoga exercise. The patents for computer-based group collaboration systems make no reference to the use of yoga exercise whatsoever. The group creative thinking sessions and brainstorming sessions mentioned in U.S. Pat. No. 3,968,573 Poliniere 1976, U.S. Pat. No. 5,183,297 Bodziak 1993, U.S. Pat. No. 5,443,387 Mortemard de Boisse 1995, U.S. Pat. No. 5,662,478 Smith 1997,and U.S. Pat. No. 5,752,837 Palmer 1998 make no reference to the use of yoga exercise whatsoever. The Kirilian photography device featured in U.S. Pat. No. 4,222,658 Mandel 1978 makes no reference to the use of yoga exercise whatsoever. The Kundalini Research Institute Journal article of June 1974 on “Kirilian Photography of Meditative States” describes how yoga and meditation can produce measurable differences in the human electromagnetic field, although the physics behind Kirilian corona discharge photography are not yet well understood. However, this article makes no reference to the use of yoga exercise in combination with group creative thinking sessions. Thus there is no prior art for the combination of methods posed by the present invention.

The following is a brief background on yoga exercise:

Yoga is an ancient exercise system known for centuries throughout the world as a means of improving physical and mental health. Yoga in the form of Kundalini Yoga as taught by Yogi Bhajan is the preferred embodiment of this invention. Kundalini Yoga has been taught to the general public around the world since 1968 through the copyrighted lectures of Yogi Bhaj an, PhD and Master of Kundalini Yoga. His lectures comprise a body of yogic technology that includes many thousands of unique yogic kriyas (specially sequenced yogic exercises) and meditations, each of which is designed to accomplish a particular effect such as balancing activity in both the left and right hemispheres of the brain. The ameliorative and restorative effects of yoga and meditation in reducing stress and improving physical and mental health are well known and well documented by modern medical science over the last 30 years. Information on some of these scientific discoveries is provided in the Information Disclosure Statement accompanying this patent application. The inventor, a student of Yogi Bhajan, has drawn upon his experience of more than 29 years as a teacher of Kundalini Yoga to implement an effective stress management program for the business corporate environment that includes the present invention, which in its preferred embodiment includes laminated instruction sheets describing specific Kundalini Yoga techniques for relieving stress, elevating mood, improving mental concentration, increasing physical health and vitality, improving communication with self and others by stimulating the chakras, also known as energy centers, in the body, expanding the human electromagnetic field, and coordinating and balancing the left and right hemispheres of the brain. Kundalini has been much described in prior yoga art, including page 137 of the book by Darshan Singh Khalsa, “Transition Stress Management At Work: How to Thrive and Succeed in the Business World,” Lions Presence Press, Phoenix Arizona 2001: “The goal of all forms of yoga is to awaken the dormant potential energy of the Kundalini (the nerve of the soul) stored at the base of the spine. When the Kundalini energy is awakened, it uncoils up the spine to the top of the head and the person experiences higher consciousness.” Chakras have been much described in prior yoga art, including Chapter 6 of Yogi Bhajan's PhD thesis “Communication: Liberation or Condemnation,” The University for Humanistic Studies, San Francisco 1980 which is incorporated by reference. Chakras are energy centers in the human body that correspond to physical locations of endocrine glands or major nerve complexes in the body, such as top of head for pineal gland, brow point for pituitary gland, throat for thyroid gland, heart for thymus gland, navel point for solar plexus, lower abdomen for gonads, and base of spine for source of Kundalini energy. According to Yogi Bhajan, the electromagnetic field of an average human being has a radius of 2.13 meters as measured from the center of the physical body. Therefore, the electromagnetic fields of two human beings begin to overlap and interact at an average distance of 4.26 meters. Yoga exercises that expand the human electromagnetic field, when practiced among a group of people in sufficiently close physical proximity to each other, have the effect of increasing and harmonizing the shared overlaps of their combined electromagnetic fields, resulting in improved group cooperation. Aside from Kirilian photography and Magnetic Resonance Imaging, modern science has not yet sufficiently developed the tools necessary to quantitatively measure or scientifically explain these effects predicted by yoga technology.

The following is a brief background on storyboarding:

Storyboarding as a form of storytelling through pictures was first developed by Leonardo Da Vinci. Storyboarding as a business process was originally developed by Walt Disney for the Walt Disney Organization in 1929 as a means of tracking the progress of his illustrators in completing animated film cartoons. Each day, the artists working on drawings for each of the scenes in the film pinned their completed drawings up on a wall-mounted storyboard so the progress of the project could be determined at a glance. Disney and the artists met daily in front of the storyboard to discuss the project and collaborate in visually rearranging scenes as decided. Storyboarding subsequently became a means of creative collaboration and decision making by project participants in major non-film projects such as the design and operation of Disney World. Eventually the storyboarding methodology spread beyond the Walt Disney Organization to the entertainment industry and into the public domain. Storyboarding as a means of visually displayed group communication and creative interaction has been widely used in the entertainment and aerospace industries for decades. The particular sequencing of group storyboarding activities described herein represents only one of many different ways that facilitators skilled in the art conduct storyboarding sessions. Prior to the present invention, there have been no applications of yoga technology combined with storyboarding to accomplish creative collaboration and enhance decision making.

One of the recognized problems with storyboarding is the unpredictability of results when there are tensions, hidden conflicts and often departmental rivalries among participants of a creative thinking session where storyboarding is utilized. No scientific methodologies to neutralize the stress of participants or to strengthen the human electromagnetic fields of participants, and thus their group interaction, have previously been applied to solve such problems.

Another recognized problem with storyboarding for group collaboration and decision making is the tendency of participants to vary rapidly between creative brainstorming, a right-brain activity, and analytical thinking, a left-brain activity, in which fluctuation between these activities significantly impedes the group process. No scientific methodologies to improve brain hemispheric balance and activity or to improve mental focus or to enhance intuition have previously been applied to solve such problems.

One of the recognized problems with creative thinking sessions is the tendency for participants to be distracted from the present activity by preoccupation with other thoughts, anxiety about unrelated events, external noise, fatigue, racing thoughts, physical discomfort, and other internal and external distractions. Yoga exercise improves physical well being, relieves stress, energizes and calms the nervous system, and increases mental focus, as is well known to those familiar with the art.

The following is a brief background on computerized videoconferencing:

Computerized videoconferencing on the Internet makes it possible for remote groups to meet electronically and contemporaneously to share and communicate auditory and visual information via live web cameras and electronic whiteboards. Group collaboration software on the Internet makes it possible for remote individuals and groups to transcend barriers of time and space to share ideas, to communicate collectively and collaboratively, but often non-contemporaneously, and to coordinate the completion of action items generated by storyboarding sessions. One such software application that is widely deployed at no extra charge on most personal computers sold today is Microsoft NetMeeting. Microsoft NetMeeting or a similar widely-available Internet videoconferencing system is a part of the preferred embodiment of the present invention.

The inventor worked for over twenty years in the computer industry as a project leader, marketing manager and business process re-engineering consultant, and is familiar with publicly-deployed computer-based Internet videoconferencing and group collaboration systems. The inventor facilitated many diverse group projects using customized storyboarding techniques as a method of sharing information and developing group collaboration and consensus.

In the year 2000, the inventor conceived of the idea of combining his knowledge and experience of twenty nine years as a Kundalini Yoga teacher with the other two technologies, and of applying that unique combination of technologies to business planning and group creative thinking processes.

The present invention was first publicly announced for sale by the inventor as a consulting service to businesses on Mar. 23, 2000. The first public demonstration of this invention was conducted on May 5, 2000 in Phoenix, Ariz. with participants at the 14^{th} Annual International Planning Center Methods Conference during and subsequent to a “Balanced Group Thinking” presentation by the inventor.

### SUMMARY

A method for leading a group of people through a process for decision making by executing a plurality of creative thinking sessions, said method comprising:

selecting a leader or a plurality of leaders of said group to act in the capacity of a yoga teacher and a facilitator;

providing yoga and meditation exercise sufficient to adjust brain functioning of participants in said group, and

conducting storyboarding to brainstorm, communicate, share and analyze ideas among participants in said group,

whereby the interaction and decision making effectiveness of said group is improved.

Said method can be used to enable groups to generate and select ideas for, but not limited to, decision making, problem solving, strategic planning, project management, situation assessment, conducting a meeting and similar creative thinking activities.

### OBJECTS AND ADVANTAGES

Although the prior arts of yoga and storyboarding have not been previously so combined, the results are synergistic. Several objects and advantages of the present invention are creative thinking sessions and business planning processes that may be rendered more effective through the use of yoga exercise including, but are not limited to, strategic planning, business process re-engineering, problem solving, project management, situation assessment, technology planning, value chain collaboration, international negotiation and conflict resolution, orientation and operational training, conducting business meetings, and many other organizational planning processes.

The ability of a group to function collaboratively in a constructive fashion is contingent upon many variables, including expressed or unexpressed common goals, expressed or unexpressed subgroup differences, familiarity of the individuals with each other, hidden conflicts and personal agendas, departmental rivalries, divergent or convergent business objectives and intentions, distractions in the environment, nonverbal communication clues, individual personality traits including introversion and extroversion, the health, energy level, stress level and well being of the participants, and many other factors. There is a large body of publicly-available research on group dynamics, which are incorporated herein by reference. The technology of yoga, and Kundalini Yoga as taught by Yogi Bhajan in particular, has proven to be effective in ameliorating many of these conditions. A search of the Medline database on the Internet under the category “yoga” reveals the vast scope of hundreds of scientific studies and medical research on yoga over the last thirty years, confirming the positive effects predicted by yoga teachings upon virtually every physical, mental, psychological and medical condition that has been examined. As the popularity of yoga has increased in recent years, these scientific findings are now finding their way into public news media such as Time Magazine and Newsweek Magazine, which recently featured information on recent scientific studies of the profound effects of yoga and meditation on the brain drawn from Dr. James Austin's 1998 book “Zen and the Brain” and Dr. Andrew Newberg's 2001 book “Why God Won't Go Away,” which are incorporated herein by reference.

If the stress level of creative thinking session participants can be reduced, their energy level elevated, their electromagnetic fields expanded, and their brains focused on the task at hand, the group is more likely to achieve rapport, and ultimately consensus, in a shorter period of time. The ability to switch from creative to analytical modes of brain functioning is also enhanced by appropriate yoga exercises. The left brain questions and the right brain accepts. Each individuals' brain hemispheres must be balanced, as that is the key to effective decision making according to Yogi Bhajan, Master of Kundalini Yoga. The published lectures and writings of Yogi Bhajan are incorporated herein by reference. The recordings and transcripts of all published and unpublished Kundalini Yoga lectures of Yogi Bhajan from 1968 to the present are archived by 3HO Foundation, Route 2 Box 4 Shady Lane, Espanola, N.Mex. 87532.

The differences between left brain hemisphere and right brain hemisphere have been well documented in medical research and popular media over the last several decades. The medical effects of normal and yogic breathing upon brain hemispheres has been researched by Shannahoff-Khalsa, Stancak, and others, in studies such as “Ultraradian rhythms of autonomic, cardiovascular and neuroendocrine systems are related in humans,” American Journal of Physiology, October 1994, 18(1):75-9; “The effects of unilateral forced nostril breathing on cognitive performance,” International Journal of Neuroscience, November 1993, 73(1-2):61-8; “EEG changes during forced alternate nostril breathing,” International Journal Psychophysiology, April 1996, 270(4 Pt 2):R873-87, which research is incorporated herein by reference. These studies found that statistically significant changes in brain functioning could be achieved in only a few minutes of particular yogic breathing exercises. The present invention includes a combination of particular sequences of brain hemisphere balancing yoga exercises which, when practiced by groups of creative thinking session participants, have the effect of altering brain hemisphere activity and coordination, thereby improving individuals' decision making capabilities and of enhancing group interaction.

Modern medical scientific research supports the contention that yoga exercises can balance the hemispheres of the brain, and thus enhance decision making. The proper sequencing of yoga exercises to achieve particular effects, such as those claimed herein, is known to those skilled in the art as the key to the effectiveness of yoga because its successive exercises adjust the nervous system and the secretions of the endocrine glandular system are sequenced and timed to cascade in a cumulative effect. The term for such a complete set of properly-sequenced yoga exercises is “kriya,” a term well known to those skilled in the art.

The yoga kriyas are then followed by storyboarding techniques in a particular sequence that invoke participants to utilize, in turn, different areas of their brains for brainstorming, sharing ideas, socially interacting, analyzing alternatives, making consensus decisions and taking ownership of any action items.

Whenever the energy of the group wanes, or a change in group direction is needed, the leader of the creative thinking session leads the group in selected yoga and meditation exercises to stimulate the appropriate areas of the body and brain. Storyboarding processes are well-known in various industries and have been the subject of published books and articles, which are incorporated herein by reference.

Videoconferencing is utilized to link physically local and remote groups of creative thinking session participants together in real-time interaction and communication via the Internet. Thus all individuals involved in a particular creative thinking session can participate at the same time in the yoga exercises and storyboarding activities. In such systems, it is often desirable to enable a plurality of presentation views of live video imaging of the participating groups, to enable audio interaction, and to provide a shared whiteboard for displaying the storyboards as they evolve for interactive visual communication during creative thinking sessions.

Followup group communication and coordination for the completion of any action items can subsequently take place via well-known and widely-deployed Internet-based group collaboration systems such as Microsoft NetMeeting® and IBM Lotus Domino®. The capabilities of such Internet-based videoconferencing and group collaboration systems are incorporated herein by reference.

Accordingly, it is an object of this invention to introduce a novel method of conducting group creative thinking sessions as a way to improve group decision making in any business planning process, problem solving process, business process re-engineering effort, project management process or other business meeting and group interaction process, whether the participants are contemporaneously physically present in the same location or remotely present.

It is another object of this invention to synergistically combine ancient and modern technologies, not previously so combined, to achieve results more effectively than any of the technologies used by themselves. The technologies, which individually already exist but have not previously been so combined, are: yoga, storyboarding and, in the preferred embodiment, computer-based Internet videoconferencing and group collaboration systems. Other objects and advantages will become apparent from the specification and drawings.

### DESCRIPTION OF THE DRAWINGS

FIG. 1 is an illustration of the main components of the invention.

FIG. 2 is an illustration of the main components of a yoga exercise session as embodied in the invention.

FIG. 3 is an illustration of the main components of a storyboarding session as embodied in the invention.

FIG. 4 shows a high level process flow diagram for implementation of the invention by a leader on behalf of a typical client.

FIG. 5 illustrates some of the specific yogic exercises typically taught to group creative thinking session participants, embodied in laminated printed instructions for the use of a yoga teacher.

FIG. 6 illustrates some standard formats of specific storyboarding processes typically taught to group creative thinking session participants, embodied in laminated printed instructions for the use of a storyboarding leader.

FIG. 7 illustrates a typical storyboard mid-way through a group creative thinking session.

FIG. 8 illustrates some examples of fully-formatted Yoga Visual Instruction Aids in the preferred embodiment of the invention.

### LIST OF REFERENCE NUMERALS

Reference# Description

101 Leader

102 Yoga Visual Instruction Aids

103 Local Participants

104 Local Video Camera

105 Local Computer

106 Internet

107 Remote Participants

108 Remote Video Camera

109 Remote Computer

110 Storyboard

111 Storyboarding Leader

112 Storyboard Visual Instruction Aids

113 Storyboard Video Camera

114 Remote Participants

115 Remote Video Camera

116 Remote Computer

201 Step 201 of Steps for Implementing a Balanced Group Thinking Session

202 Step 202 of Steps for Implementing a Balanced Group Thinking Session

203 Step 203 of Steps for Implementing a Balanced Group Thinking Session

204 Step 204 of Steps for Implementing a Balanced Group Thinking Session

205 Step 205 of Steps for Implementing a Balanced Group Thinking Session

206 Step 206 of Steps for Implementing a Balanced Group Thinking Session

207 Step 207 of Steps for Implementing a Balanced Group Thinking Session

208 Step 208 of Steps for Implementing a Balanced Group Thinking Session

209 Step 209 of Steps for Implementing a Balanced Group Thinking Session

210 Step 210 of Steps for Implementing a Balanced Group Thinking Session

211 Step 211 of Steps for Implementing a Balanced Group Thinking Session

212 Step 212 of Steps for Implementing a Balanced Group Thinking Session

213 Step 213 of Steps for Implementing a Balanced Group Thinking Session

214 Step 214 of Steps for Implementing a Balanced Group Thinking Session

215 Step 215 of Steps for Implementing a Balanced Group Thinking Session

216 Step 216 of Steps for Implementing a Balanced Group Thinking Session

217 Step 217 of Steps for Implementing a Balanced Group Thinking Session

218 Step 218 of Steps for Implementing a Balanced Group Thinking Session

219 Step 219 of Steps for Implementing a Balanced Group Thinking Session

220 Step 220 of Steps for Implementing a Balanced Group Thinking Session

221 Step 221 of Steps for Implementing a Balanced Group Thinking Session

222 Step 222 of Steps for Implementing a Balanced Group Thinking Session

223 Step 223 of Steps for Implementing a Balanced Group Thinking Session

224 Step 224 of Steps for Implementing a Balanced Group Thinking Session

225 Step 225 of Steps for Implementing a Balanced Group Thinking Session

226 Step 226 of Steps for Implementing a Balanced Group Thinking Session

227 Step 227 of Steps for Implementing a Balanced Group Thinking Session

### DESCRIPTION OF THE INVENTION—PREFERRED EMBODIMENT

The present invention contemplates an effective decision making process using yoga exercise to balance participant's brain hemispheres for more effective group decision making, interaction, education and collaboration. The invention can be implemented by integrating selected yogic exercises with storyboarding techniques and, in the preferred embodiment, computerized Internet-based videoconferencing and group collaboration systems.

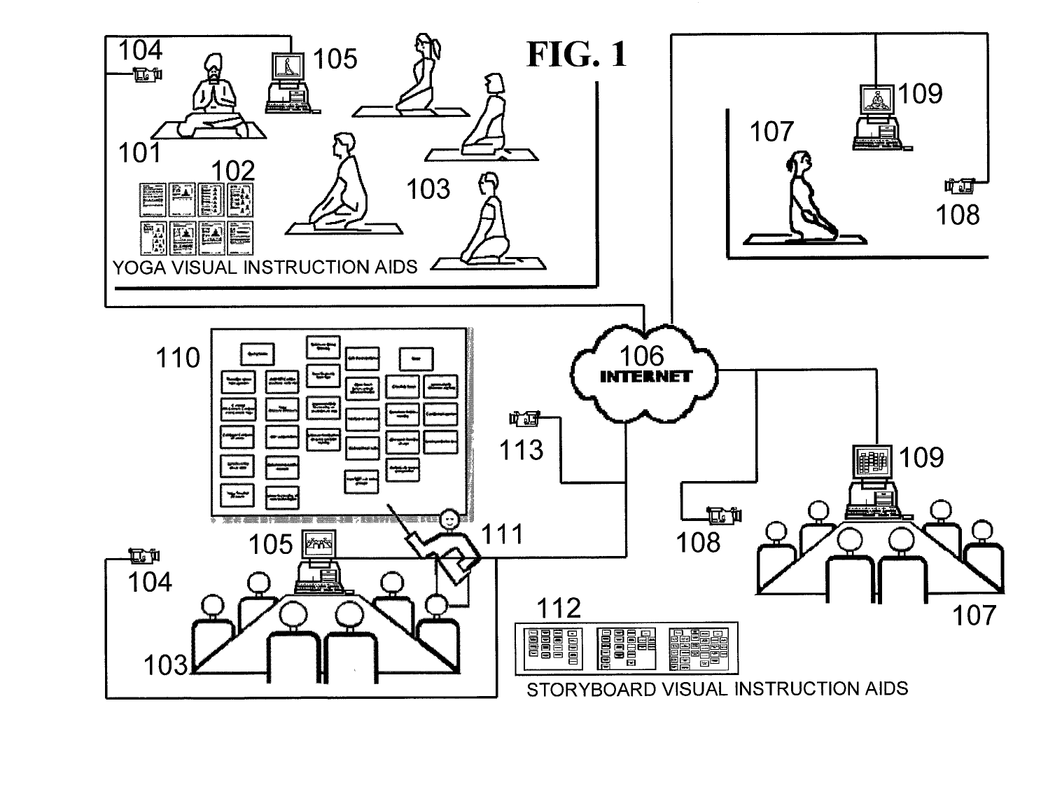

FIG. 1—Balanced Group Thinking

Referring now to the drawings, wherein like numerals refer to like components, there is disclosed in FIG. 1, broad aspects of the preferred embodiment. Individual elements within the various Figures hereinafter are sequentially numbered starting at “101” and shown in bold font.

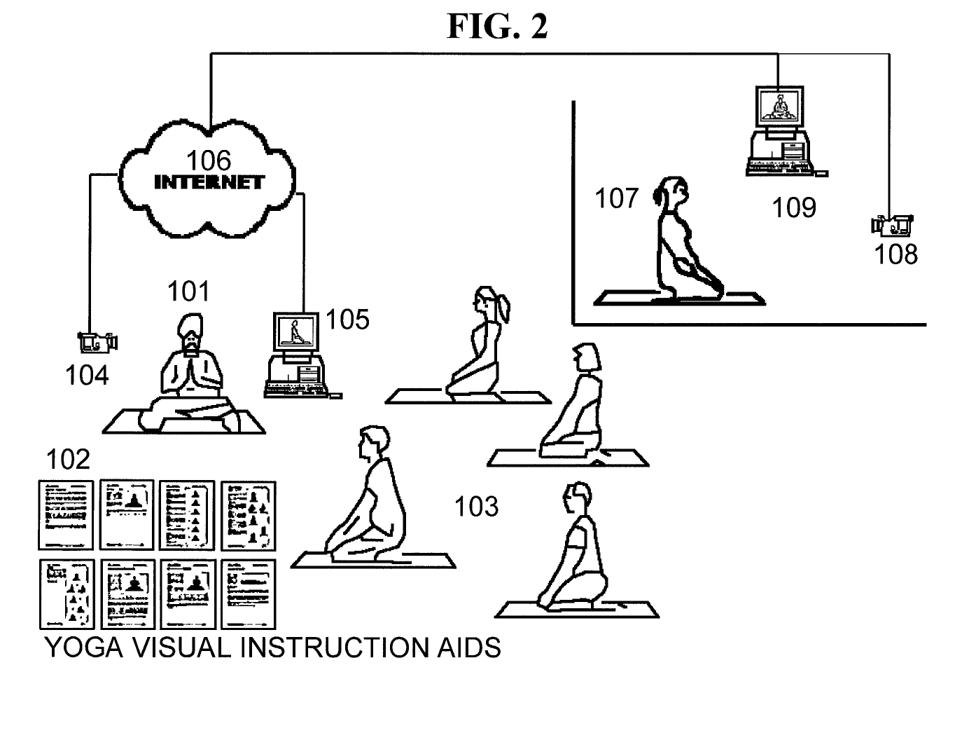

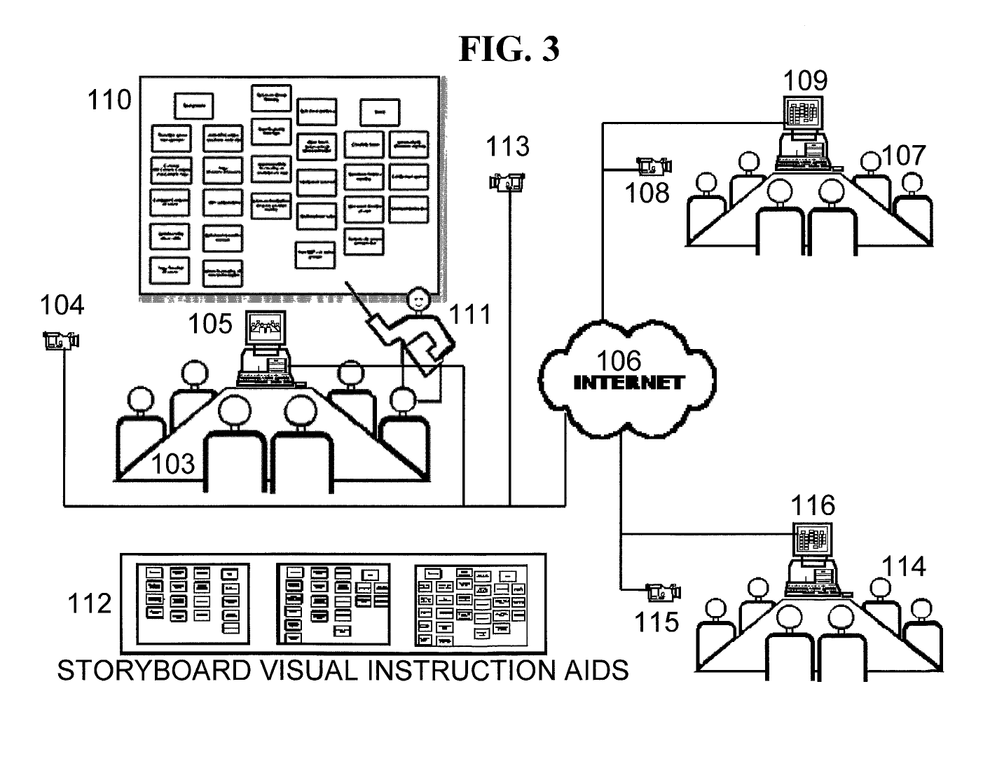

A group of people gather contemporaneously for a Balanced Group Thinking session. At least one leader is selected capable of teaching yoga exercises and facilitating storyboarding. A typical Balanced Group Thinking session begins with selected yoga exercises, the process of which is depicted in FIG. 1 and FIG. 2. Next, storyboarding begins, the process of which is depicted in FIG. 1 and FIG. 3. Then, additional yoga exercises are practiced as necessary to further adjust the brain functioning and energy level of the group, the process of which is depicted in FIG. 1 and FIG. 2.

A typical Balanced Group Thinking session has the same people participating in all activities. Some people are Local Participants 103 who participate locally in relation to the physical facility where a Leader 101 is located, while other people are Remote Participants 107 who optionally may participate remotely. Local Participants 103 are videoconferenced via the Internet 106, which includes all necessary cabling and networking connections, in real-time to one or more groups of Remote Participants 107 so that all participants can participate collectively in all Balanced Group Thinking activities.

FIG. 2—Yoga Exercise

Referring now to FIG. 2, the main components of a yoga exercise session are depicted as embodied in the invention. Leader 101 leads Local Participants 103 through performance of the various yoga exercises, which are printed on paper and enclosed in durable clear laminated plastic sheets as Yoga Visual Instruction Aids 102. The yoga exercises take place periodically throughout the Balanced Group Thinking session. Participants perform yoga exercises on the floor, or while sitting on exercise mats on the floor in the preferred embodiment of the invention, or while sitting on chairs, according to flexibility and experience of the participants, the amount of room space available, and the discretion of the yoga teacher Leader 101. The yoga exercises are broadcast real-time to Remote Participants 107, if any, over the Internet 106 via the videoconferencing system as Local Video Camera 104 sends a real-time video image and sound of the Leader 101 and the local participants to the Remote Participants 107 so they can perform the identical yoga exercises simultaneously with the local participants via the Internet 106. Leader 101 monitors and guides the real-time yoga actions of Remote Participants 107 by viewing audio-video information captured by Remote Video Camera 108 as displayed on Local Computer 105, which is part of the videoconferencing system. The Remote Participants 107 receive their real-time instruction and guidance from the Leader 101 as viewed and heard on Remote Computer 109 over the Internet 106 via the videoconferencing system. Software typically used for real-time Internet videoconferencing is sufficient to meet the requirements for Balanced Group Thinking, such as Microsoft NetMeeting®, which is provided free in most personal computers. Microsoft NetMeeting includes real-time bidirectional audio and video communication and shared electronic visual whiteboards for multiple participants on the Internet.

Subsequent to the conclusion of the initial Balanced Group Thinking session, participants may optionally communicate and share ideas and track the completion of their mutual action items via the Internet through commercially available group collaboration software such as IBM Lotus Domino that has been installed on all Local Computers 105 and Remote Computers 109 and 116.

FIG. 3—Storyboarding

Referring now to FIG. 3, the typical physical setup is depicted for storyboarding activities during a Balanced Group Thinking session. In front of the group is at least one easily readable large wall display Storyboard 110 of typical dimensions 1.3 meters high by 2.6 meters wide by 2.5 centimeters thick. For Remote Participants 107, the storyboard is visible via the videoconferencing system or, in an alternate embodiment, is optionally visible as a computer screen projection display if the storyboard is automated on an electronic whiteboard using commercially available videoconferencing software such as Microsoft NetMeeting used in combination with graphic display software such as Microsoft PowerPoint or Microsoft Visio, upon which the group's ideas are visually transcribed and displayed as they are expressed during the storyboarding process.

One key to the utility of the storyboard is that, in the preferred embodiment, the ideas displayed on it can be easily rearranged at will according to the group's requirements. The Storyboarding Leader 111, who may be the same person as the yoga exercise Leader 101, is the facilitator of the storyboarding activities. The Storyboard 110 may be composed of a variety of physical materials, such as fabric over Styrofoam® board, or may be an entirely electronic representation. A physical storyboard is typically lightweight, under 2.5 kilograms, and can have a felt, fabric or cork surface so that individual index cards may be affixed to it using push pins or similar devices, or alternately, for example, a physical storyboard may be a series of contiguous and non-contiguous sheets of ordinary blank flipchart paper taped to the wall of the group's room with masking tape so that individual Post-It Notes® sheets or similar device may be affixed to it using built-in adhesive backing. In summary, any physical or electronic representation of a storyboard with moveable cards is sufficient so long as it is easily visible and readable by all participants local and remote.

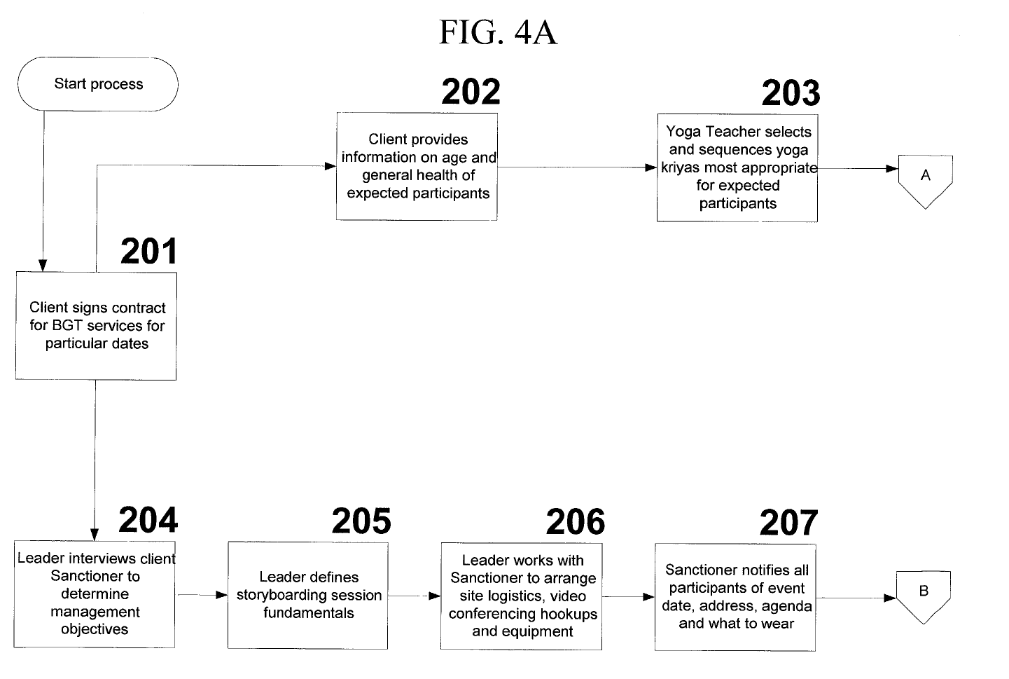

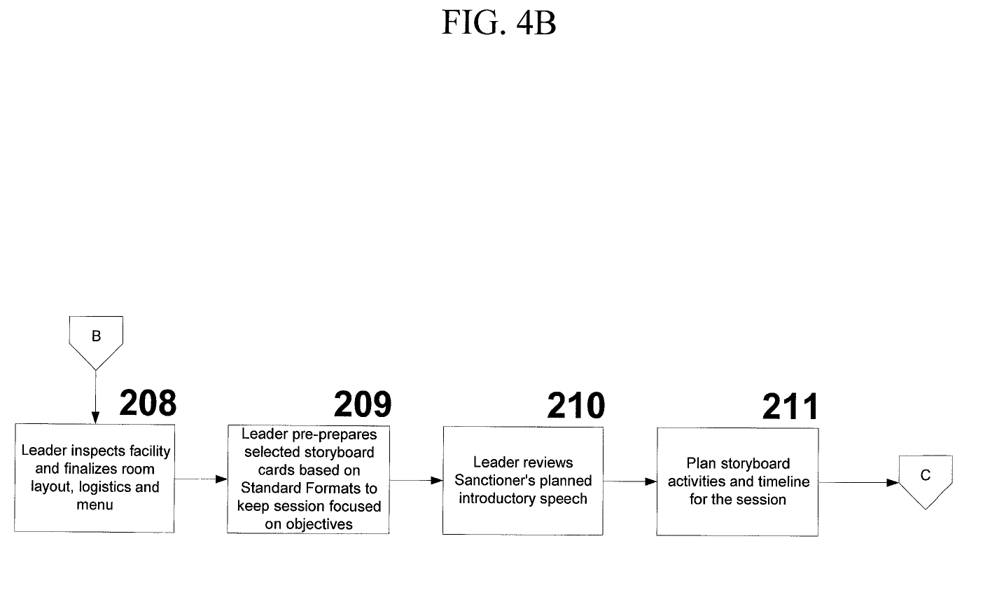

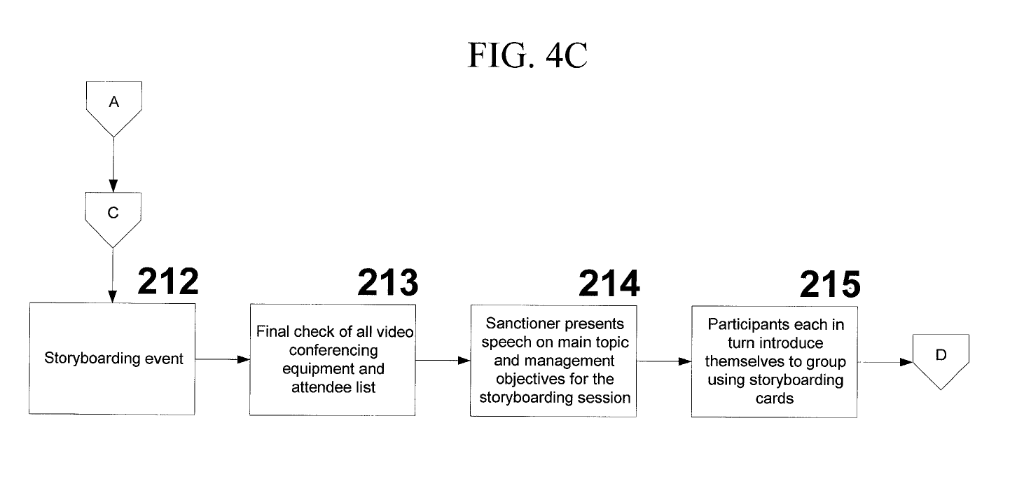

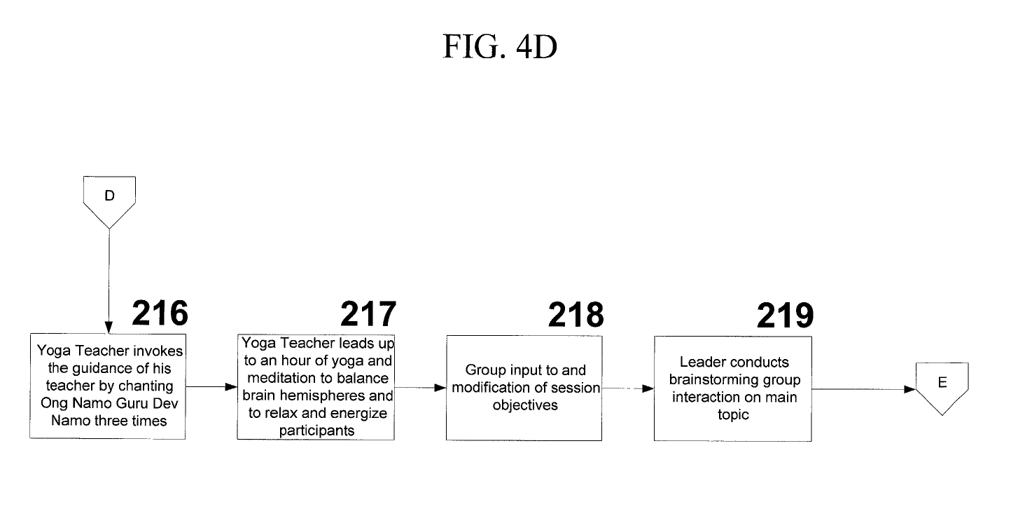

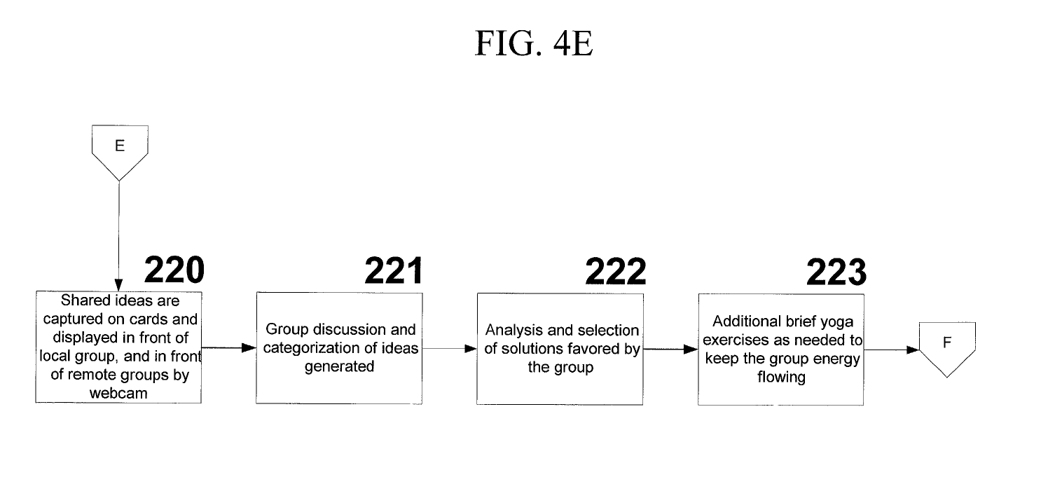

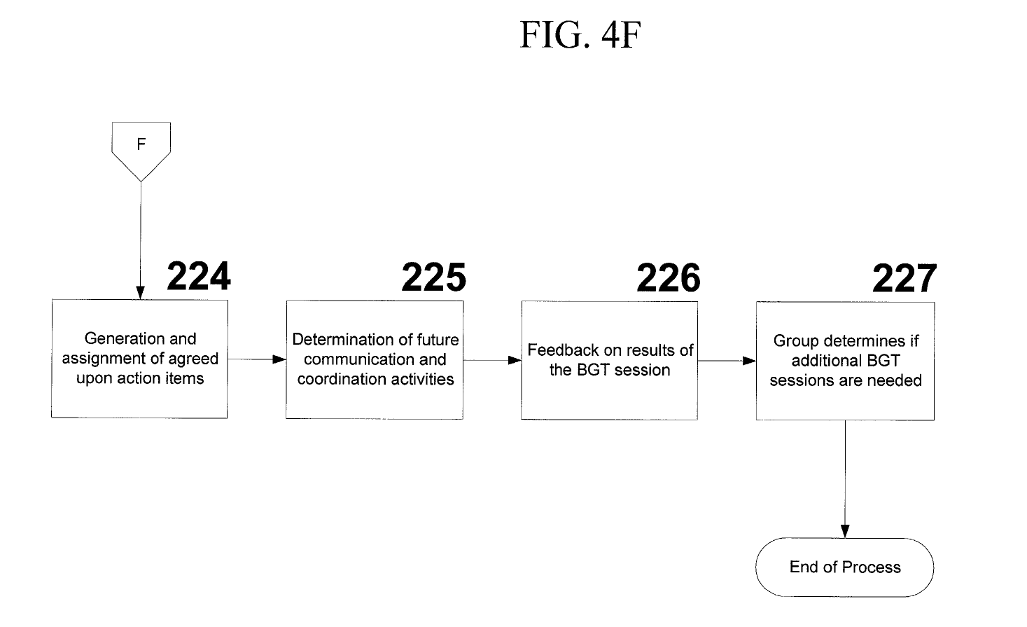

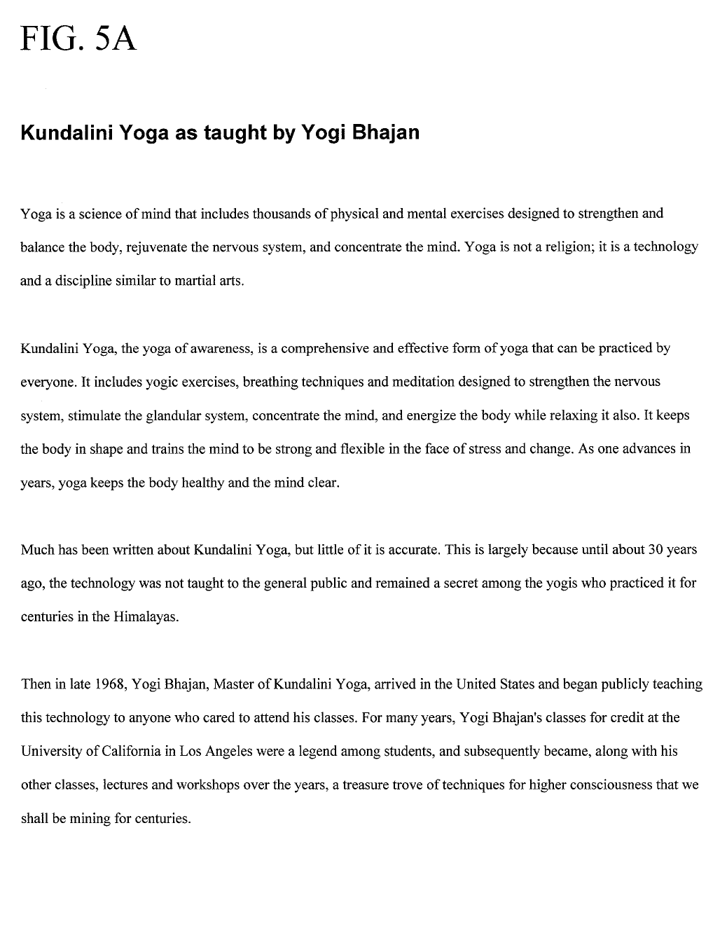

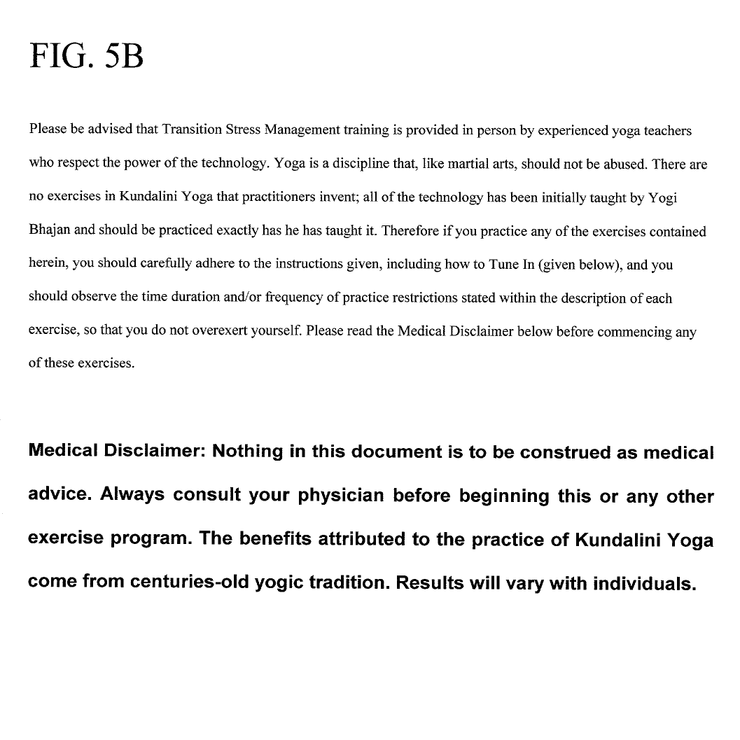

The leader structures the storyboarding activities in sequence in advance based upon suggested standard formats of Storyboard Visual Instruction Aids 112 provided through this invention to achieve the desired objectives, or, in an alternate embodiment, based upon storyboard formats the leader may have utilized in previous engagements. The leader also performs other session planning activities as described in FIG. 4.

The Local Participants 103 are typically seated in the same room with the Storyboard 110 so that it is easily visible and readable to each participant. A Local Computer 105 running commercially available software such as Microsoft NetMeeting is used to link the local participants with remote participating groups, if any, via the Internet 106 for real-time videoconferencing and interaction. The screen of the computer should be capable of displaying live video feeds from the remote sites during the storyboarding process to improve live feedback and interaction among all participants. Local Video Camera 104 sends a real-time video image and sound of the local participants to the remote participants via the Internet 106 as part of the videoconferencing system. Storyboard Video Camera 113 simultaneously sends a real-time video image of the changing Storyboard 110 to the remote participants via the Internet 106 as part of the videoconferencing system.

One or more groups of optionally Remote Participants 107 and 114 can participate in the Balanced Group Thinking session via the Internet 106. Remote Computers 109 and 116 run commercially available software such as Microsoft NetMeeting to link the remote participants with other participating groups via the Internet 106 for real-time videoconferencing and interaction. The screen of each computer should be capable of displaying live video feeds from the other sites during the storyboarding process to improve live feedback and interaction among all participants. Remote Video Camera 108 sends a real-time video image and sound of the Remote Participants 107 to the other participants via the Internet 106 as part of the videoconferencing system. Remote Video Camera 115 simultaneously sends a real-time video image and sound of more Remote Participants 114 to the other participants via the Internet 106 as part of the videoconferencing system.

FIG. 4—Steps for Implementing a Balanced Group Thinking Session

Referring now to FIG. 4, the Leader should follow certain sequential operational procedures to implement a successful Balanced Group Thinking session. The operation of the invention is described in the “Operation of the Invention” section of this patent application.

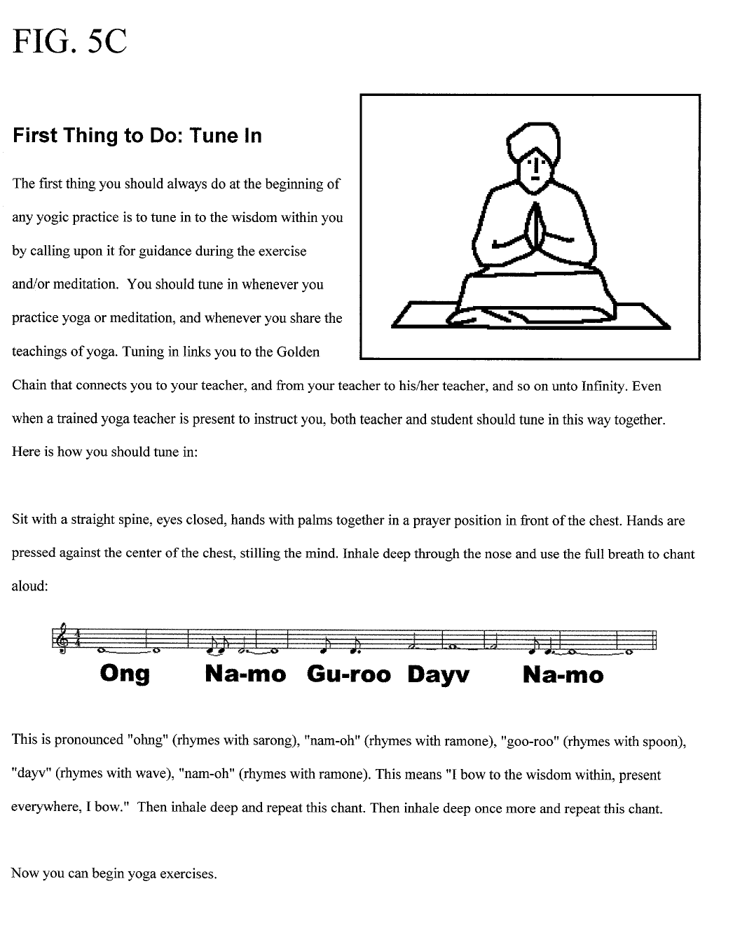

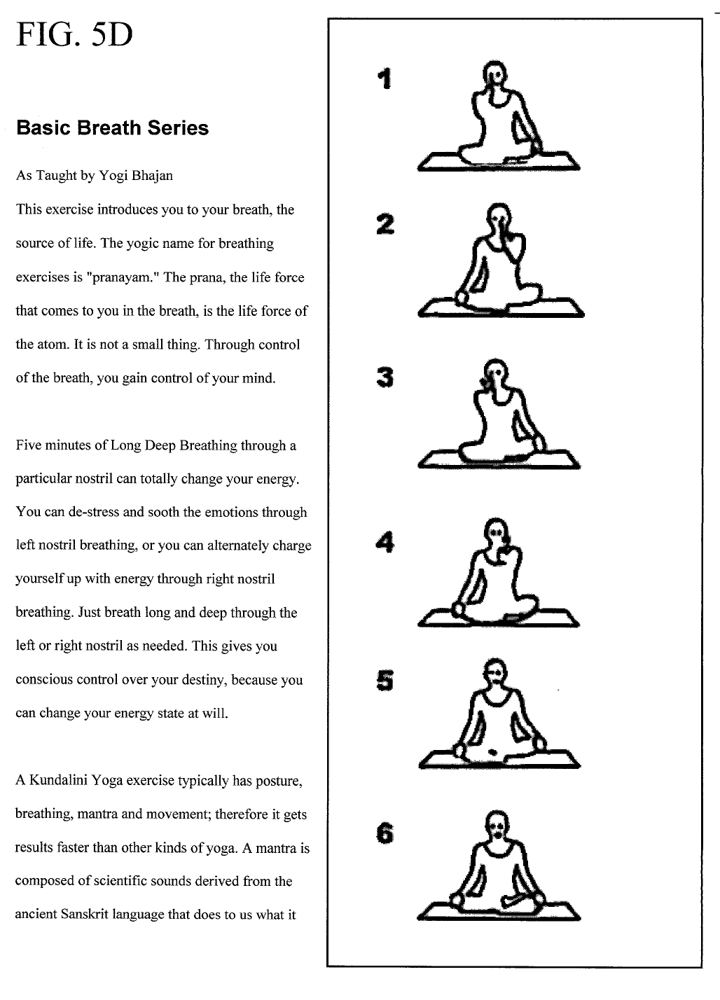

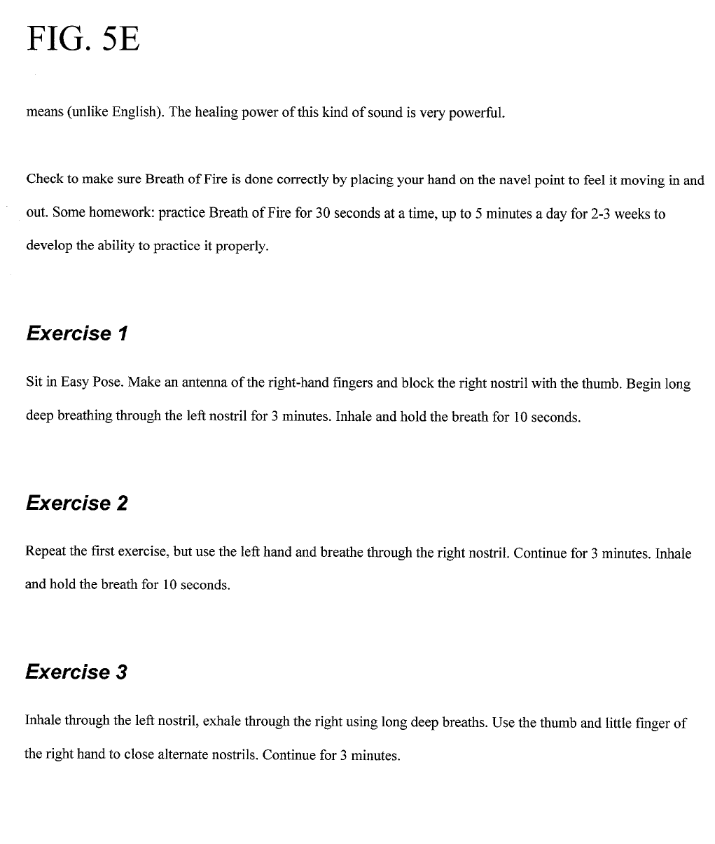

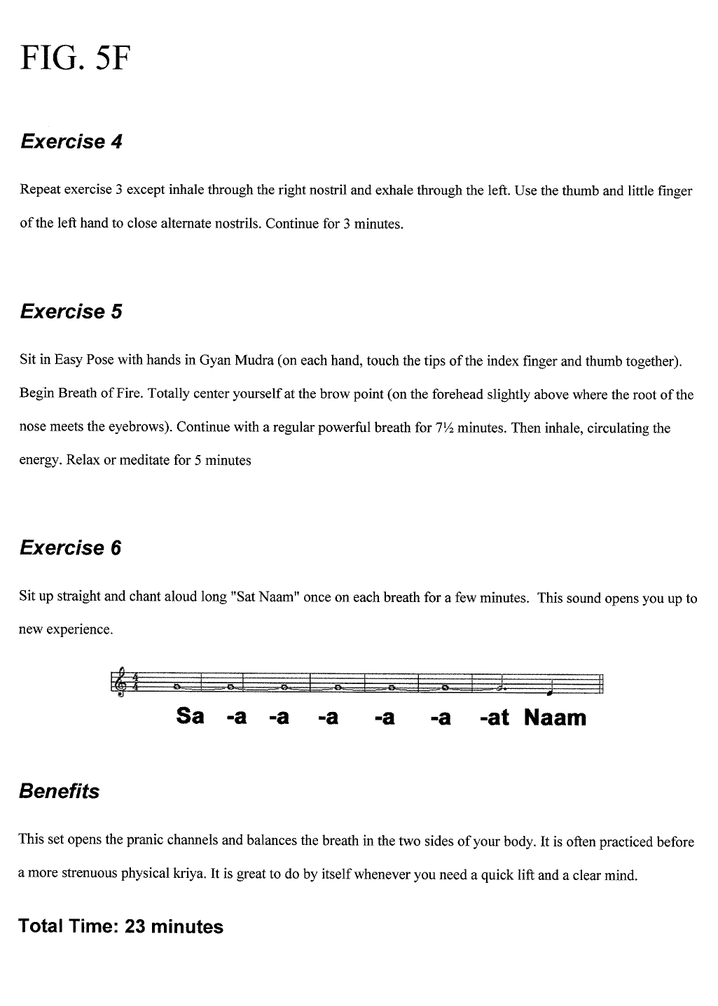

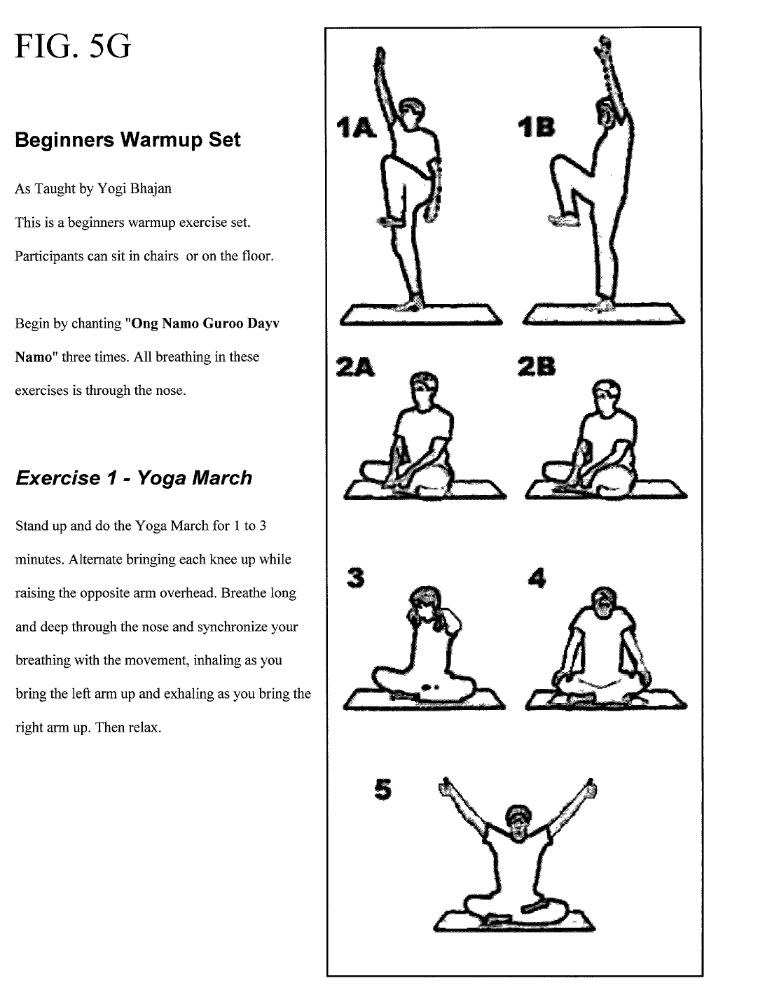

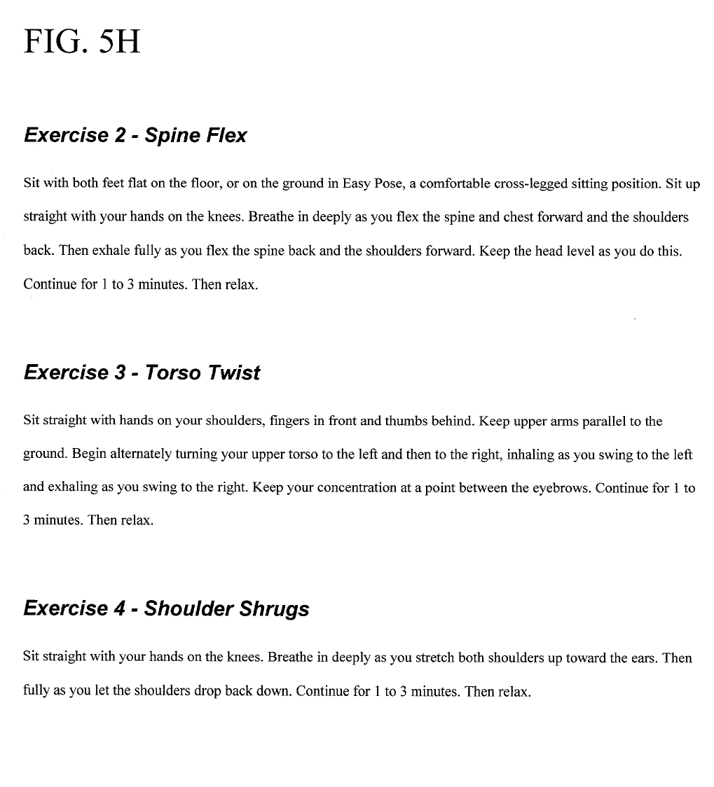

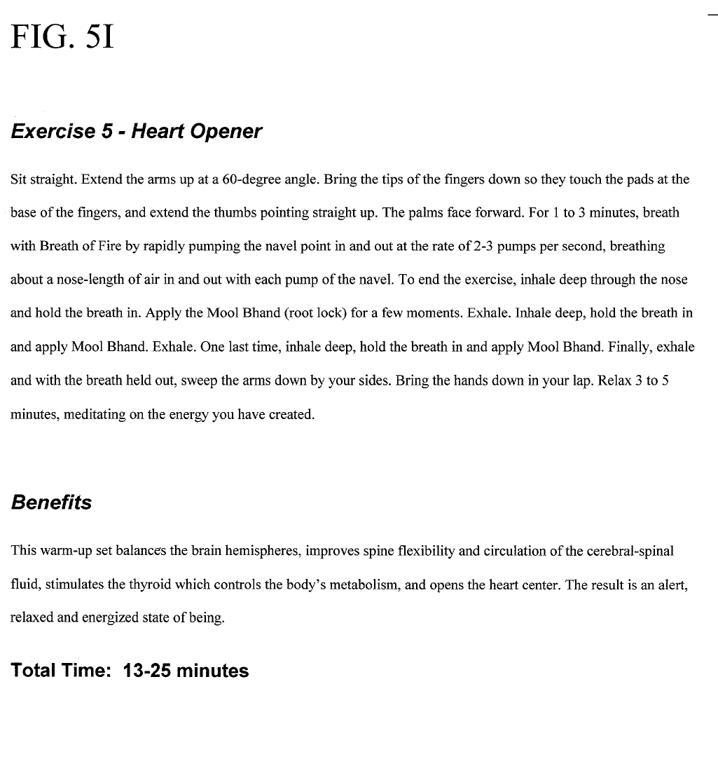

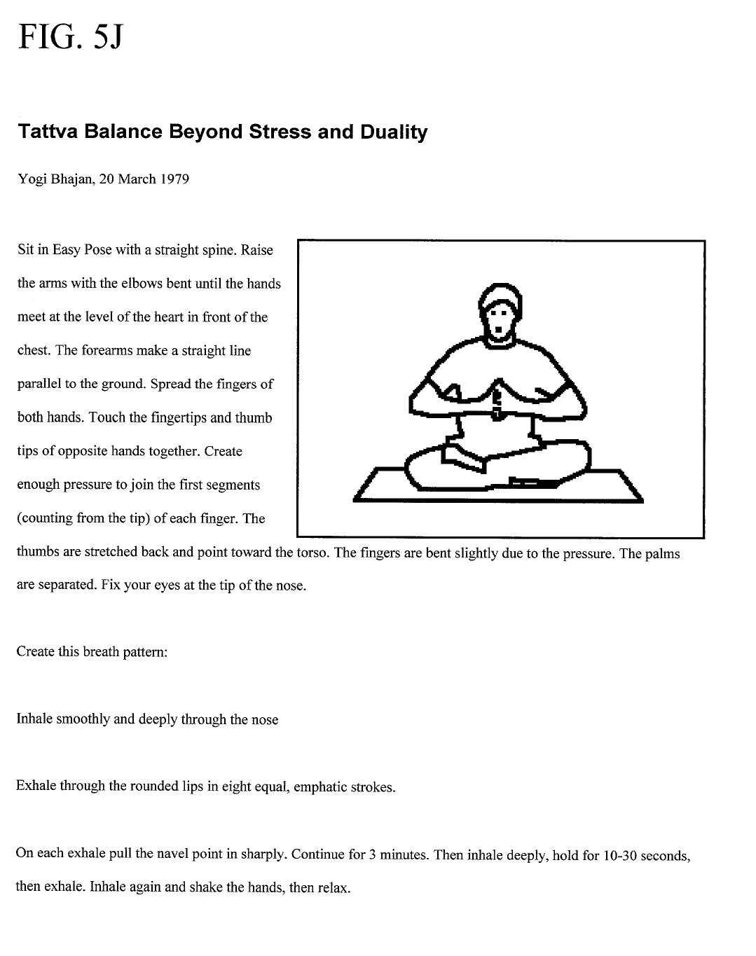

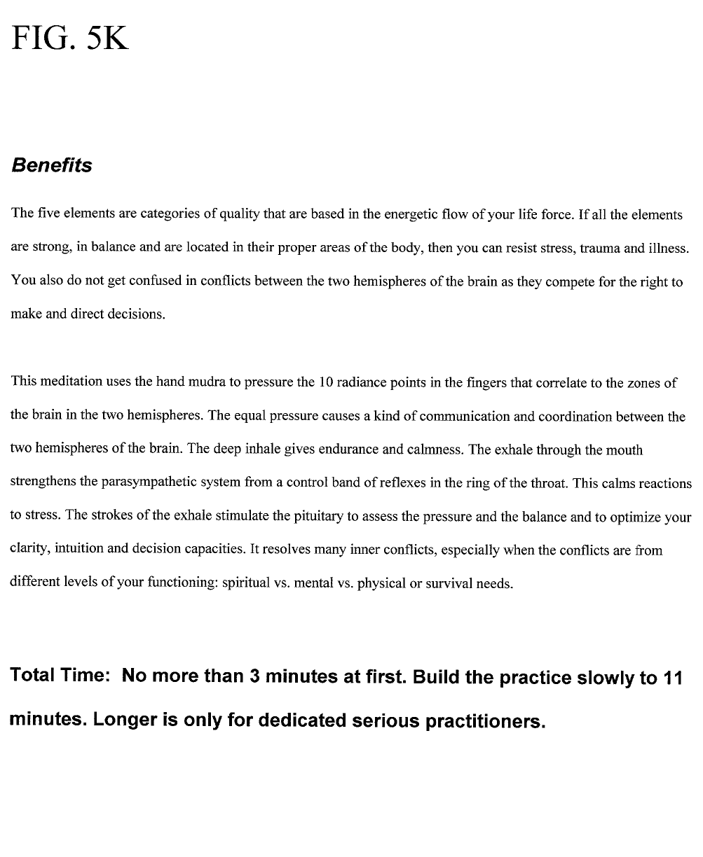

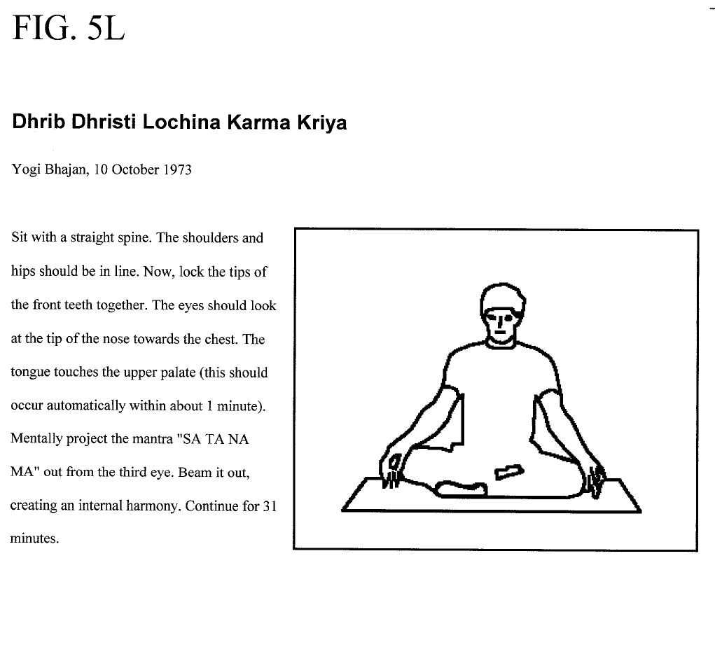

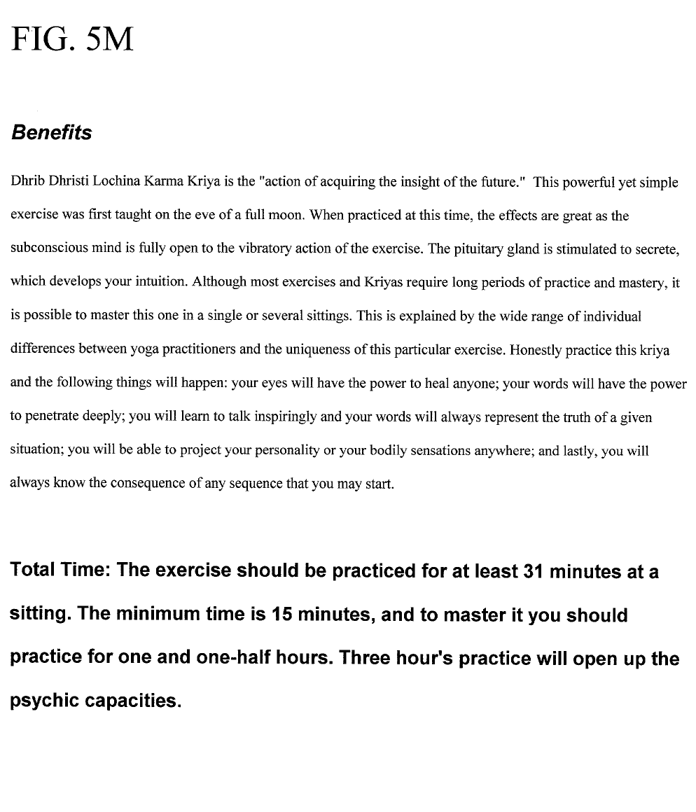

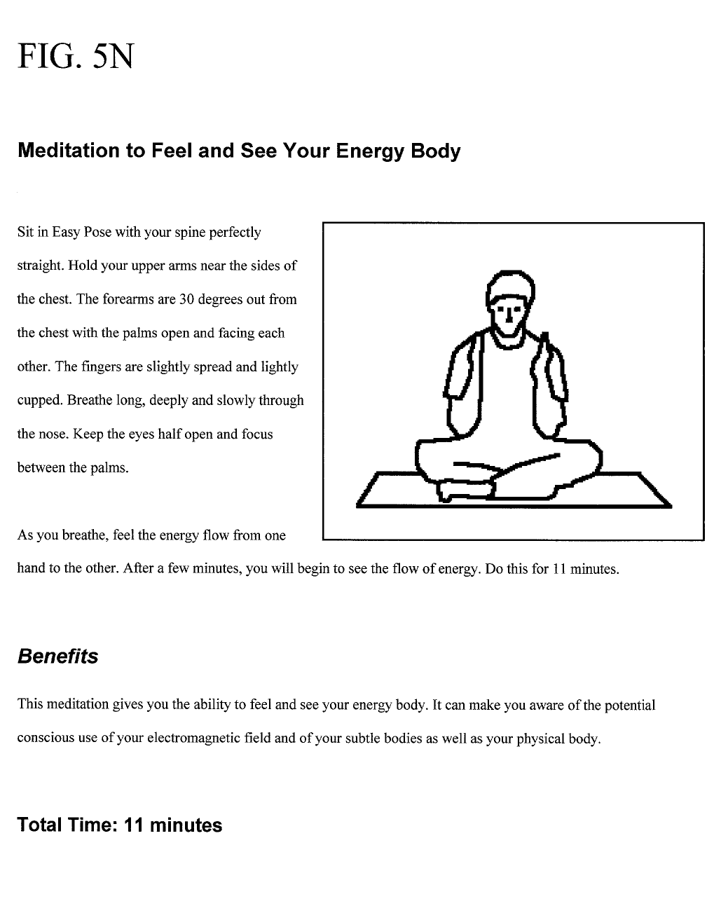

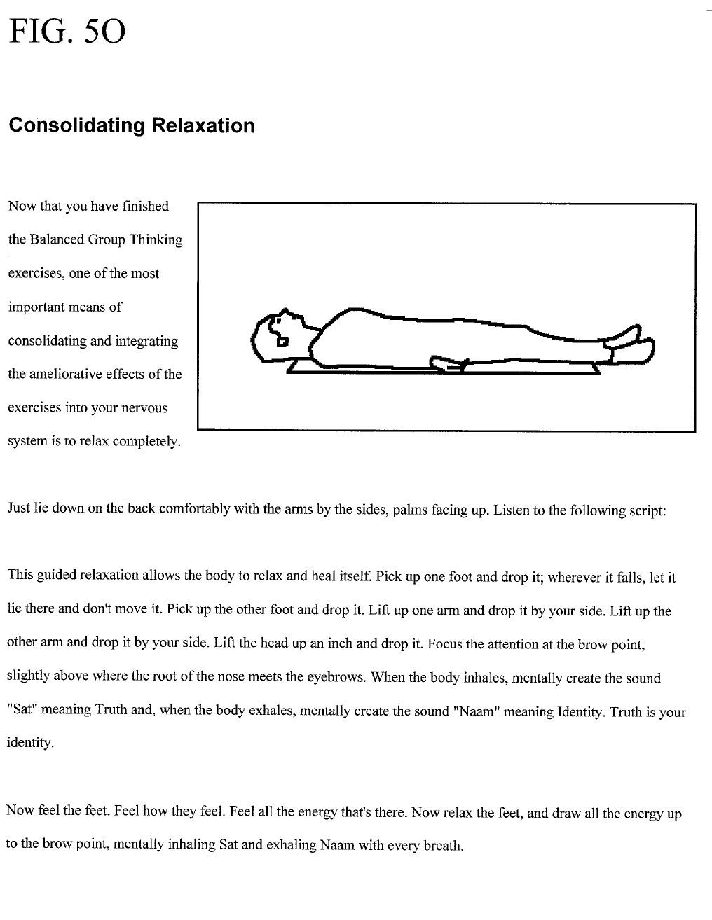

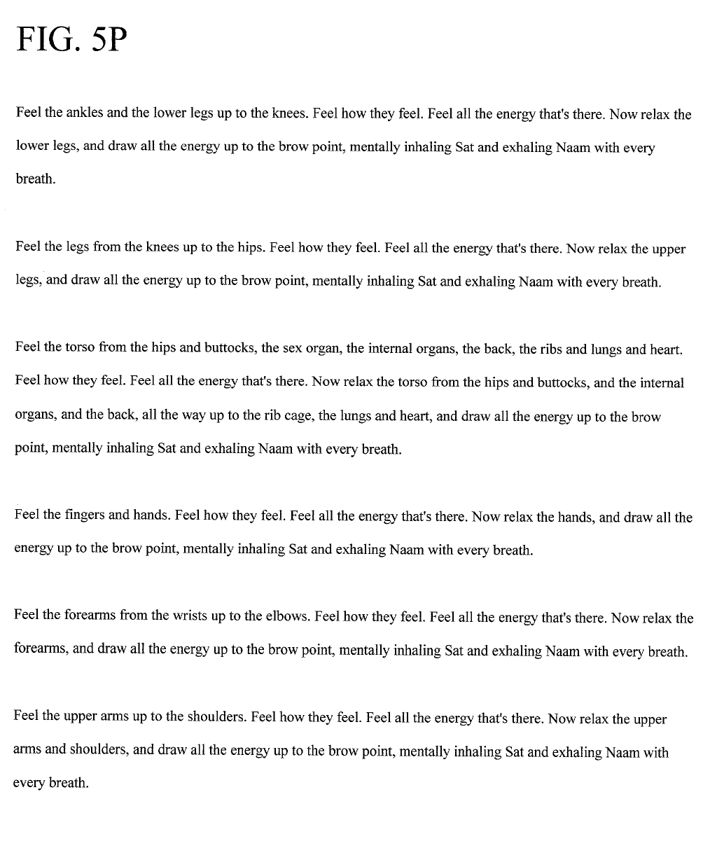

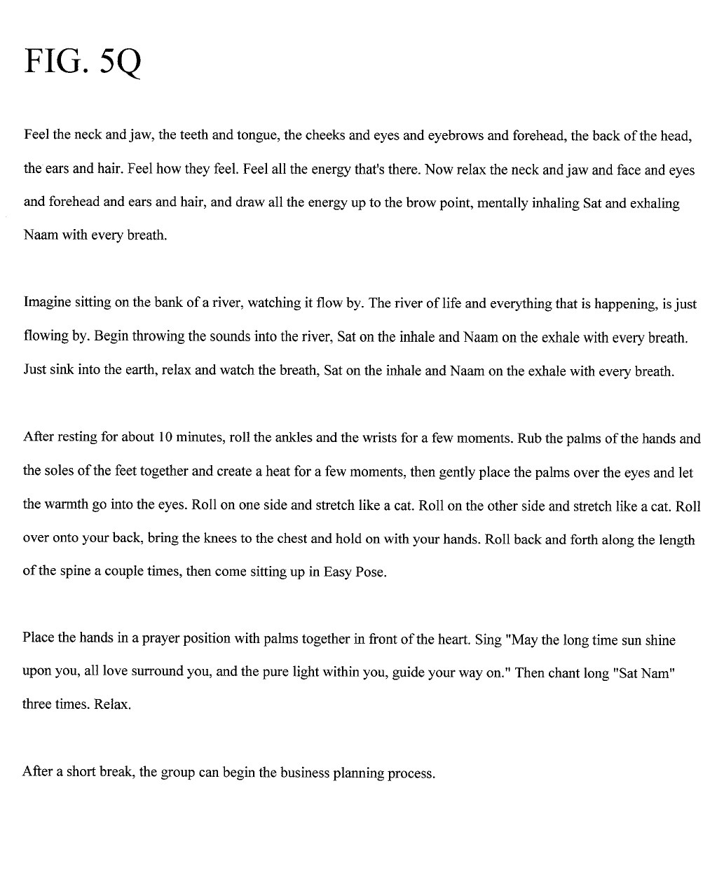

FIG. 5—Yoga Visual Instruction Aids

Referring now to FIG. 5, yoga exercise technology is depicted which stimulates each participant's nervous system, strengthens the nervous system, reduces stress, increases mental concentration, stimulates the chakras, expands the electromagnetic field, and secretes the endocrine glandular system including pituitary gland and pineal body within the brain to elevate awareness, thus stimulating intuition and creativity. These typical yoga exercises and, in the preferred embodiment, other yoga exercises drawn from the 3HO Foundation archives of Kundalini Yoga as taught by Yogi Bhajan, are embodied in laminated printed instruction sheets as Yoga Visual Instruction Aids 102, and can be made available to Balanced Group Thinking yoga teachers through the inventor or assignee, or, in an alternate embodiment, may be derived from experience by one skilled in the art.

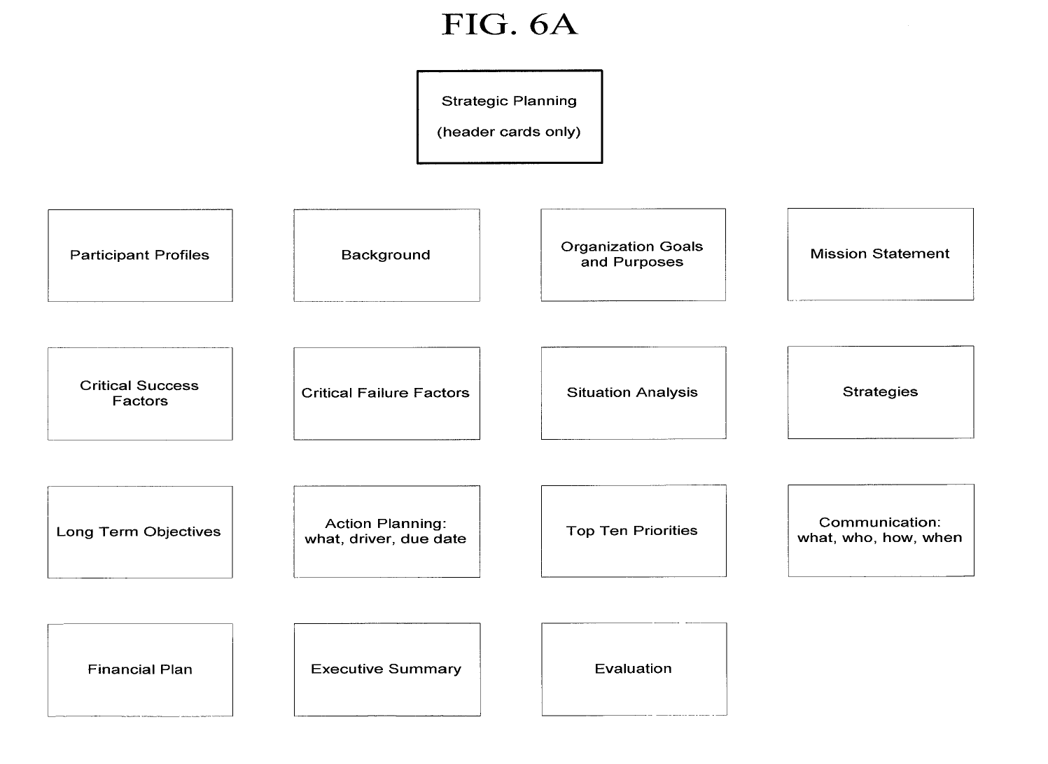

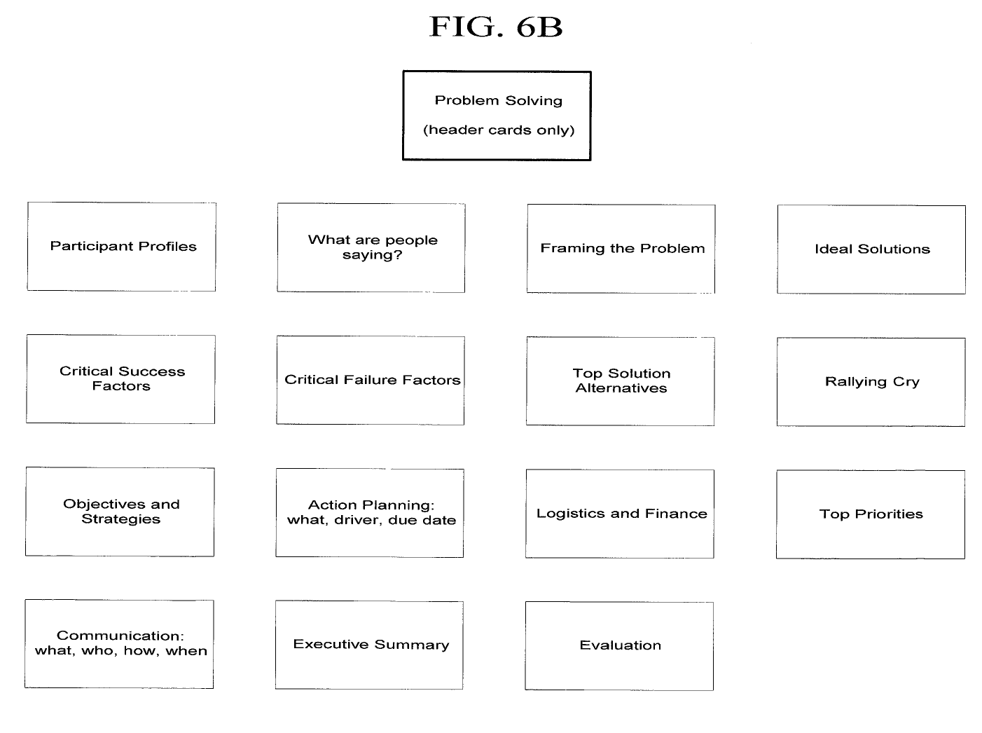

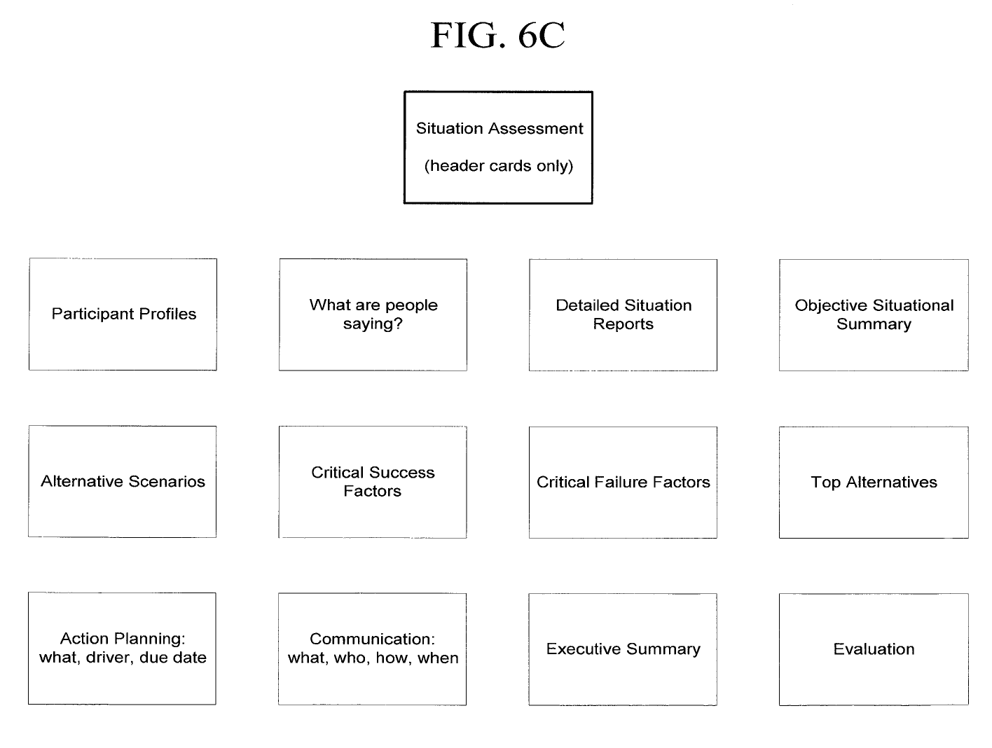

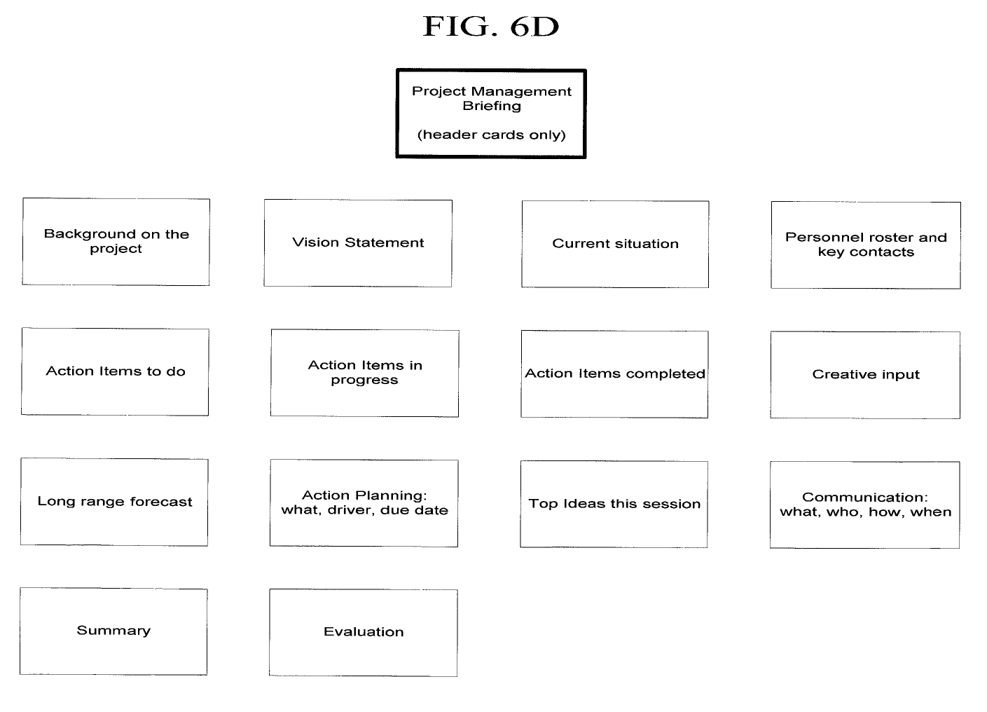

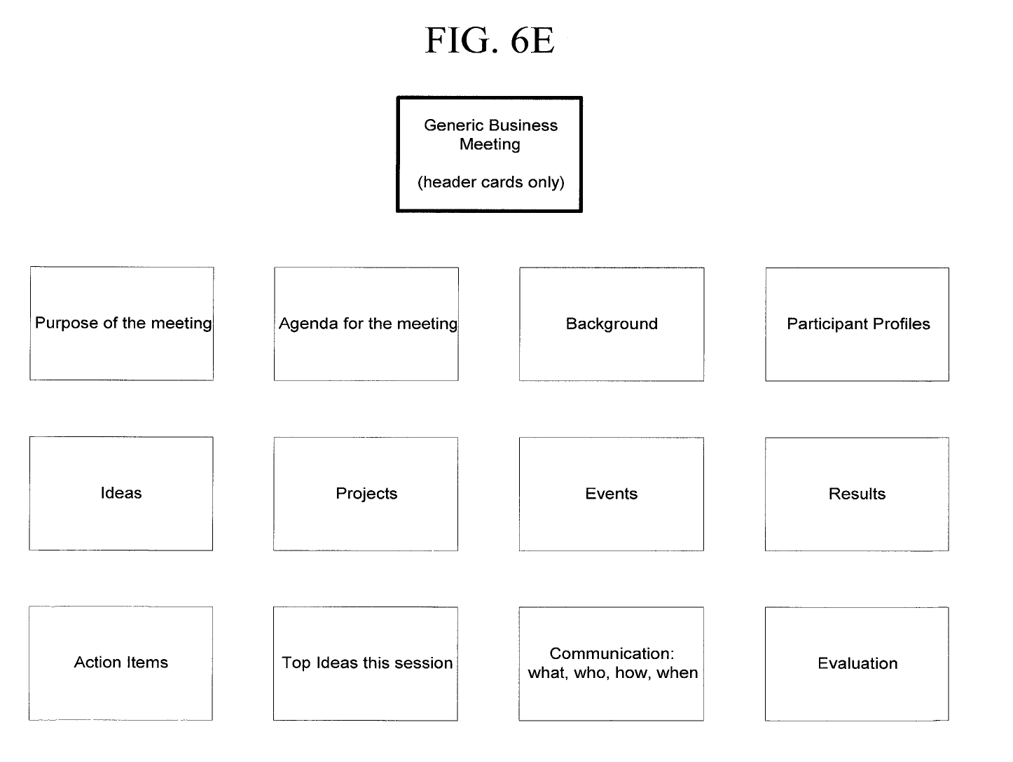

FIG. 6—Storyboard Visual Instruction Aids

FIG. 6 illustrates some of the specific standard formats of Storyboard Visual Instruction Aids 112 for storyboarding processes typically taught to Balanced Group Thinking session participants, embodied in laminated printed instructions for the use of the storyboarding leader and made available, in the preferred embodiment, through the inventor or assignee, or, in an alternate embodiment, may be derived from experience by one skilled in the art.

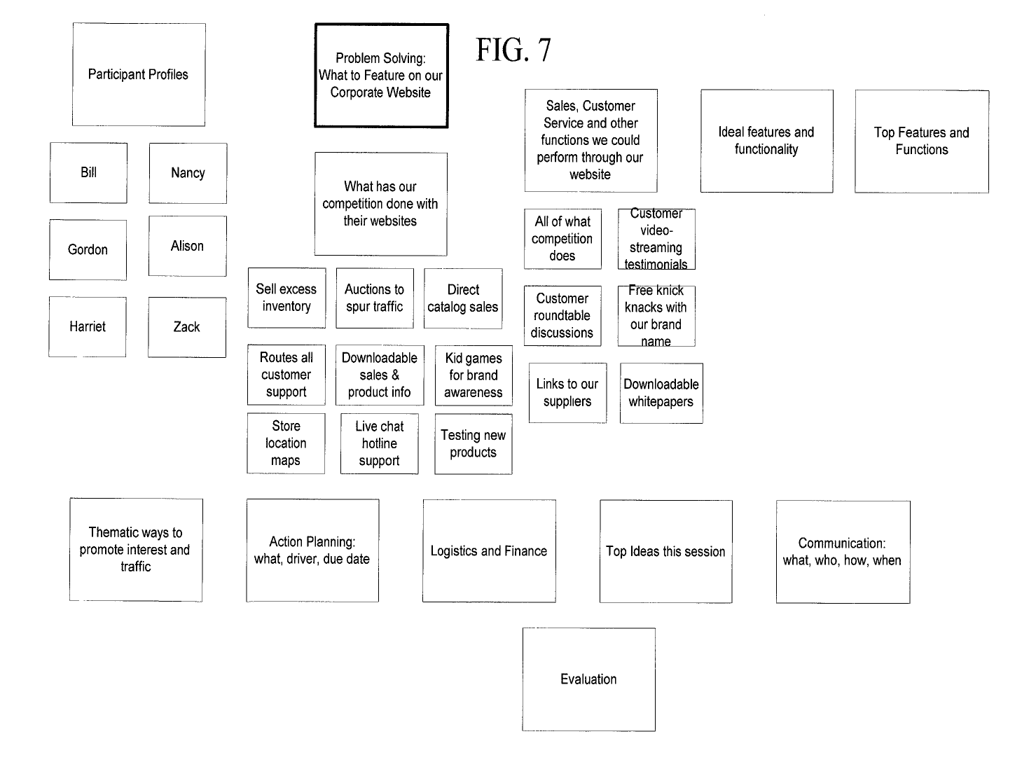

FIG. 7—Example of a Storyboard In Process

FIG. 7 illustrates a typical storyboard mid-way through a Balanced Group Thinking storyboarding session; in this example the storyboard represented is a snapshot of a group's ideas and discussion for solving a particular problem at the moment when this evolving discussion has not yet reached the stage when group can achieve consensus on the issues being considered.

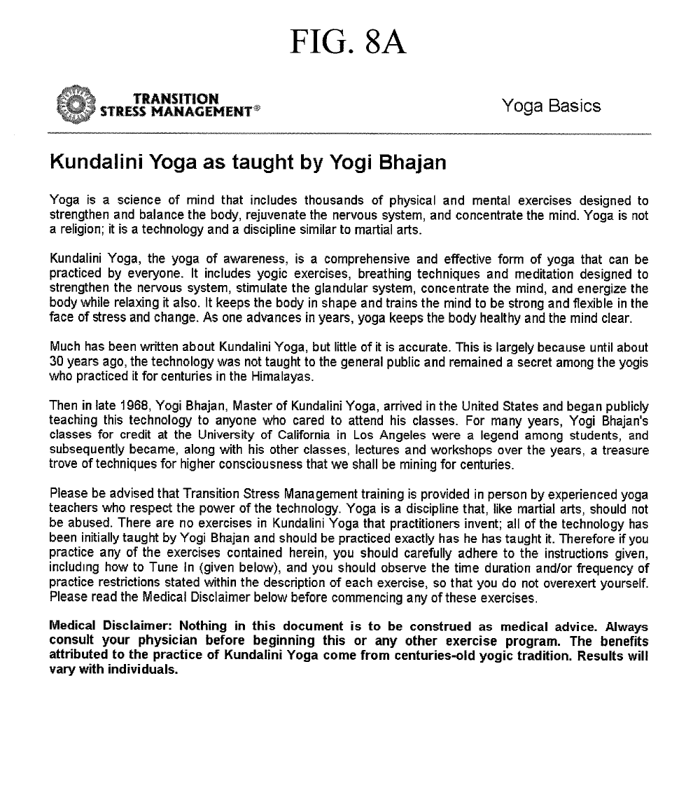

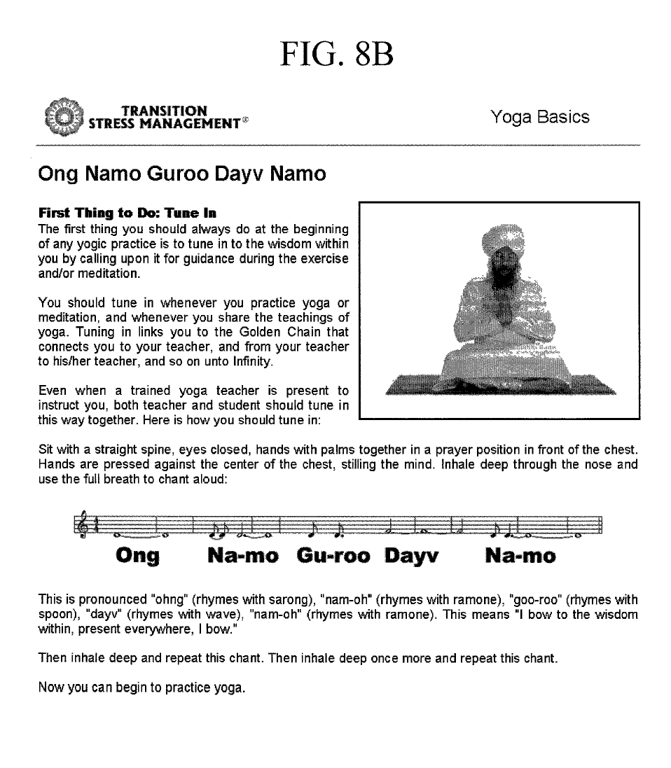

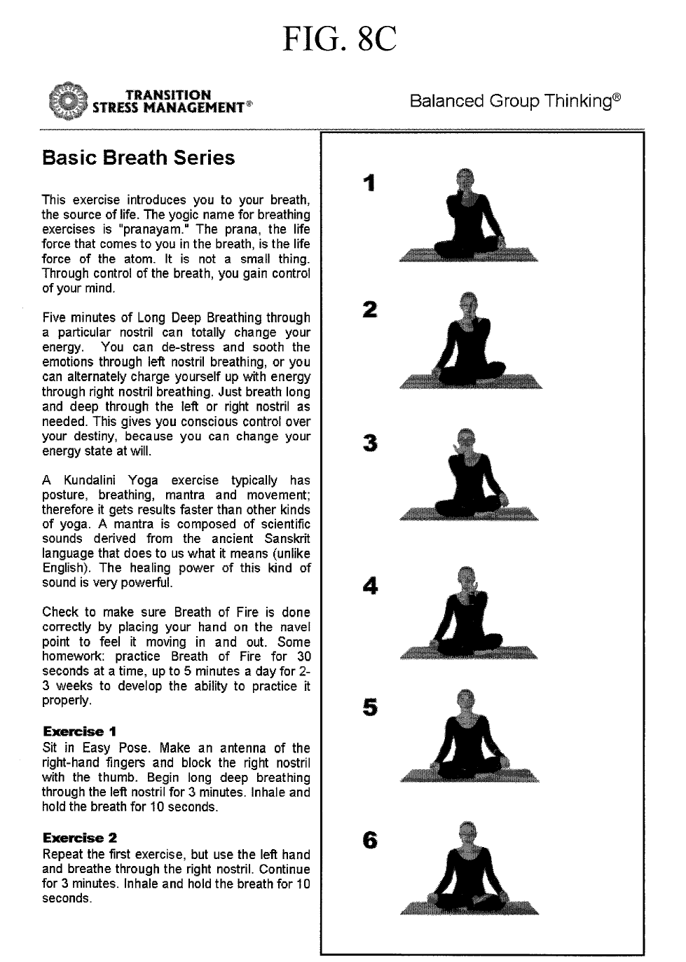

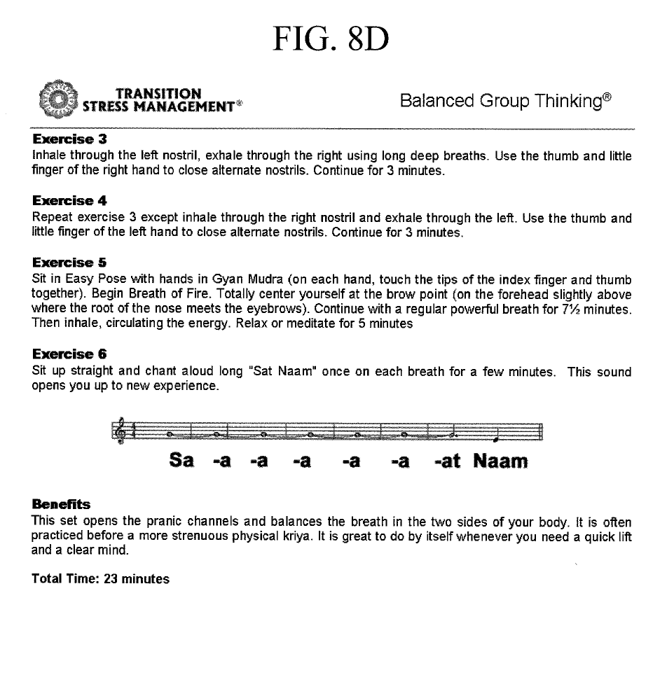

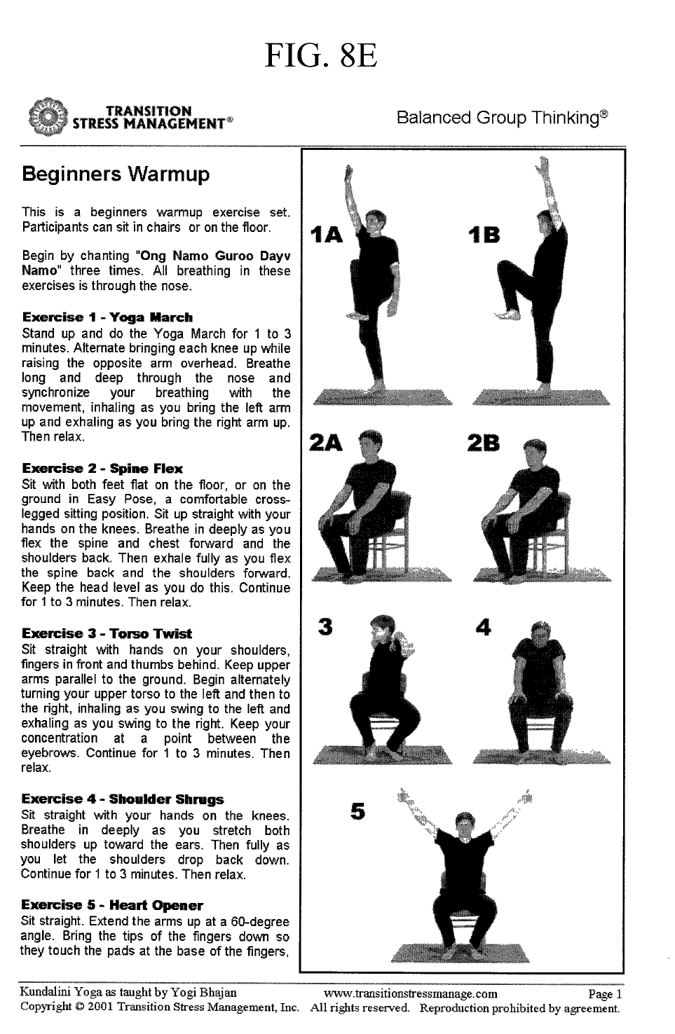

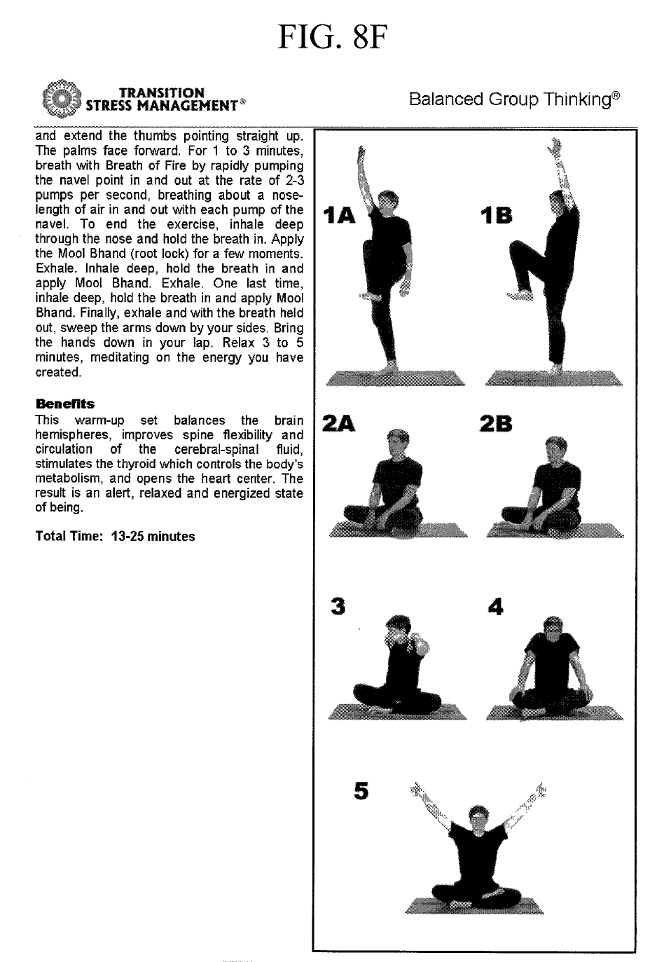

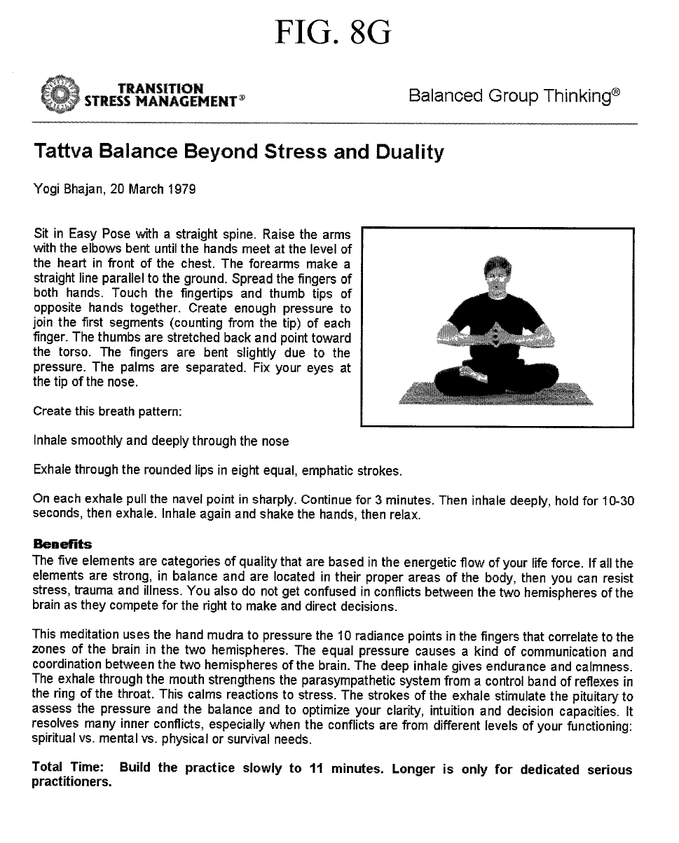

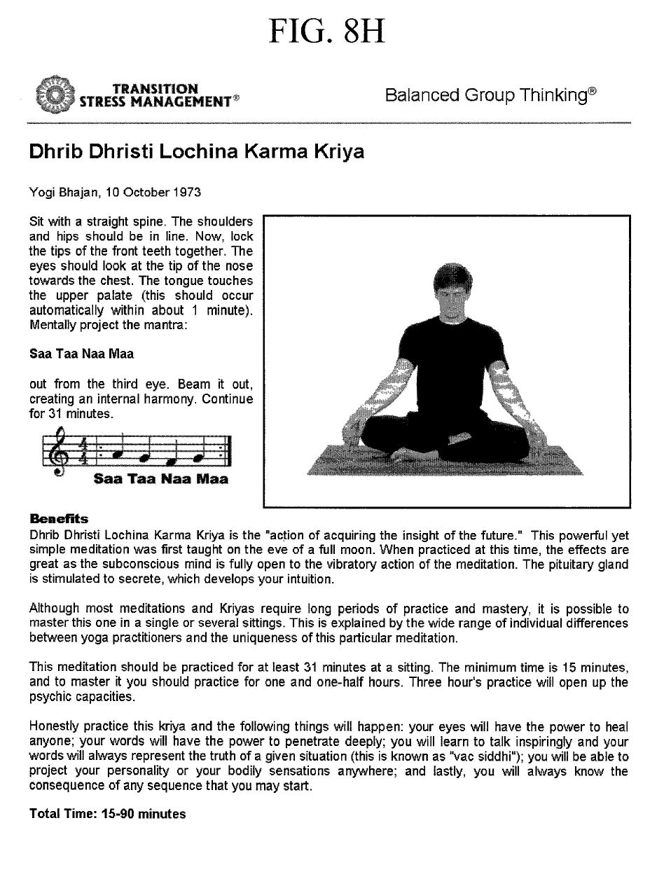

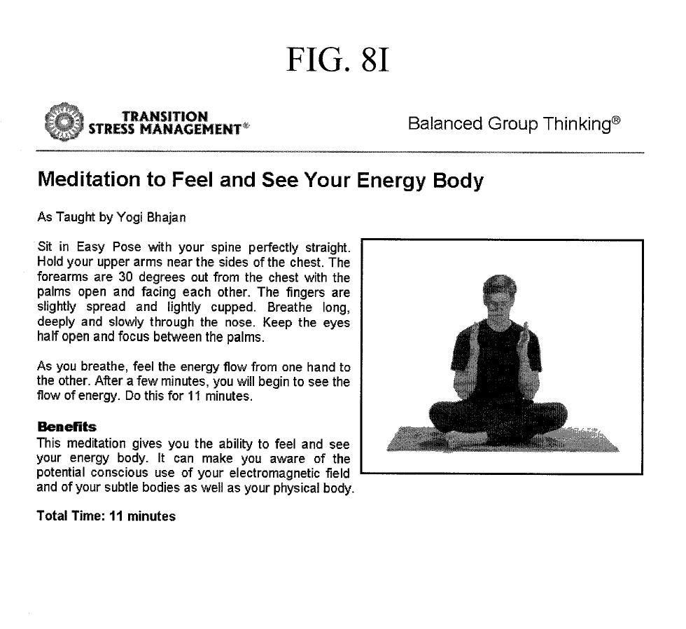

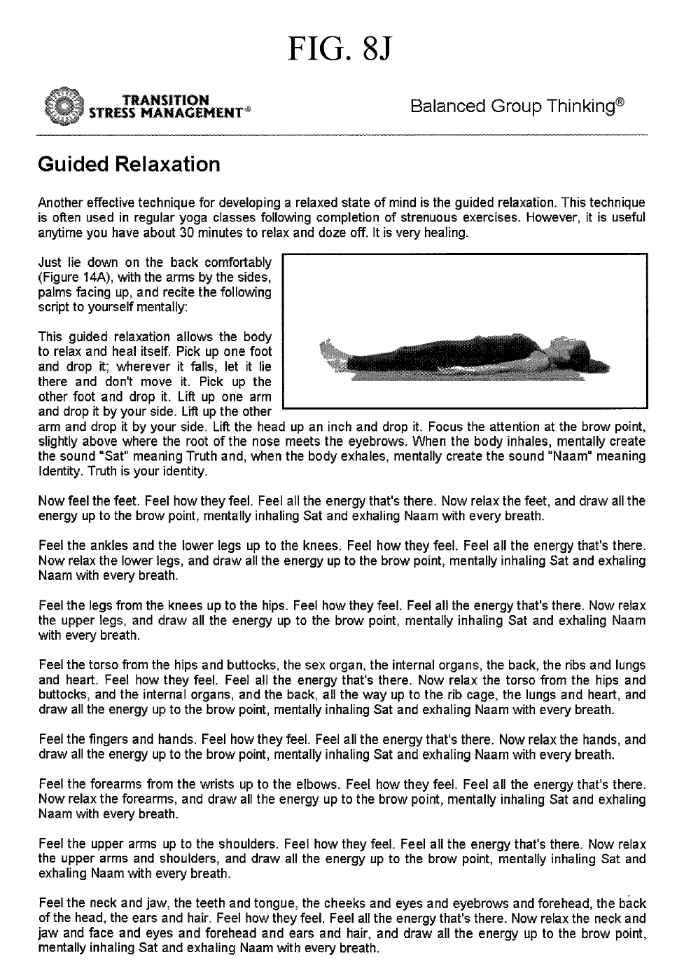

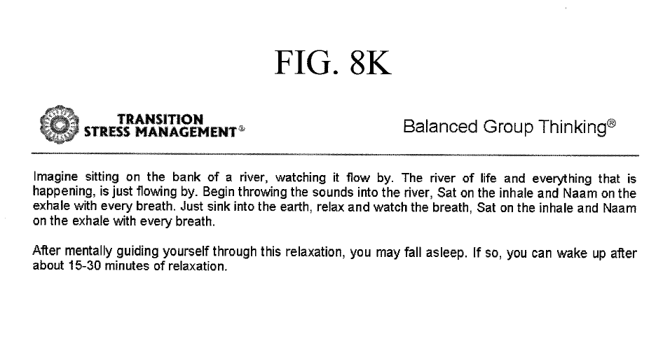

FIG. 8—Examples of Yoga Visual Instruction Aids

FIG. 8 depicts in a series of 12 pages some examples of typical fully-formatted Yoga Visual Instruction Aids in the preferred embodiment of the invention as printed instruction sheets within clear plastic lamination. Each of the 12 pages of FIG. 8 is labeled on the back with a figure number from 8A to 8L. FIGS. 8A and 8B explain how to begin yoga exercise. FIGS. 8C, 8D and 8E illustrate a typical warm-up breathing exercise. FIGS. 8F and 8G illustrate a typical Balanced Group Thinking yoga exercise that can be performed while sitting in a chair or while sitting on the ground. FIG. 8I illustrates a yoga exercise that causes the two hemispheres of the brain to communicate and coordinate more effectively, develops endurance and calmness, strengthens the sympathetic and parasympathetic nervous systems, calms reactions to stress, and stimulates the pituitary gland to secrete to optimize mental clarity, intuition and decision making capacities. FIG. 8I illustrates a yoga exercise that stimulates the intuitive and creative part of the brain by stimulating the pituitary gland to secrete within the brain. FIG. 8J illustrates a yoga exercise that provides an experience of the human electromagnetic field. Finally, FIGS. 8K and 8L illustrate a typical relaxation that concludes a series of yoga exercises.

The examples in FIG. 8 are only a small sampling of the many possible embodiments of the invention. Accordingly, the scope of the invention should be determined not by the embodiments illustrated, but by the appended claims and their legal equivalents.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims and their legal equivalents.

Operation of the Invention—Preferred Embodiment

The present invention contemplates an effective business planning process using Kundalini Yoga to balance participant's brain hemispheres for more effective group decision making, education and collaboration. The invention can be implemented by integrating selected yogic exercises with storyboarding techniques and Internet-based videoconferencing and group collaboration systems.

Additionally, the term “storyboarding” is used hereinafter to indicate any business planning activities in which group ideas are expressed verbally and then shared visually with the group as a whole in the form of one or more wall display formats or functionally-similar computer screen formats wherein each idea, once shared with the group, is printed on as separate storyboarding card or displayed within a separate visual box, whether located in the same facility or remotely connected via Internet-based videoconferencing and group collaboration systems.

FIG. 1—Balanced Group Thinking

Referring now to the drawings, wherein like numerals refer to like components, there is disclosed in FIG. 1, broad aspects of the preferred embodiment. Individual elements within the various Figures hereinafter are sequentially numbered starting at “101” and shown in bold font.

A typical Balanced Group Thinking session begins with selected yoga exercises in FIG. 2 in a specific sequence designed to improve participants' alertness, elevate energy level, stimulate the chakras, open the heart to compassion and empathy with others, reduce stress and increase mental receptivity to new ideas, expand the electromagnetic field, balance the hemispheres of the brain for effective decision making, and finally stimulate intuition and creativity.

Once a dynamic group energy is generated through yoga, the storyboarding process begins in FIG. 3. The storyboarding processes, when facilitated by one skilled in the art, stimulate creative, non-judgmental thinking, accelerate the expression and communication of ideas among participants, equalize voluble and less voluble participants, display and organize the evolving shared ideas visually, segregate creative thinking activity (right brain hemisphere) and analytical thinking activity (left brain hemisphere) so they are asynchronous and non-interfering, and broaden the perceived commonalities among participants so that consensus is more easily achieved. Much brain research has shown that the left hemisphere of the brain questions, and the right hemisphere of the brain accepts. The brain hemispheres must be balanced to make a good decision, according to Yogi Bhajan, Master of Kundalini Yoga.

Different storyboarding activities utilized in a given session are typically customized to meet specific management objectives. A typical storyboarding sequence for strategic planning, problem solving or status assessment begins with a brief presentation of the objectives of the session, introduction of participants to each other, group modification of session objectives, group brainstorming of ideas germane to the objectives, group discussion and categorization of ideas generated, analysis and selection of favored solutions, generation and assignment of agreed upon action items, determination of future communication and coordination activities, and feedback on results of the session. This sequencing of activities is a key to meeting the objectives of a storyboarding session.

FIG. 2—Yoga Exercise

Referring now to FIG. 2, the main components of a yoga session as embodied in the invention are depicted. Leader 101 leads Local Participants 103 through performance of the various yoga exercises printed on paper and enclosed in clear laminated plastic sheets as Yoga Visual Instruction Aids 102 that take place periodically throughout the Balanced Group Thinking session. The yoga exercises are broadcast real-time to Remote Participants 107, if any, over the Internet 106, which includes all necessary cabling and networking connections, via the videoconferencing system as Local Video Camera 104 sends a real-time video image and sound of the Leader 101 and the local participants to the Remote Participants 107 so they can perform the identical yoga exercises simultaneously with the local participants via the Internet 106. Leader 101 monitors and guides the real-time yoga actions of Remote Participants 107 via Remote Video Camera 108 on Local Computer 105, which is part of the videoconferencing system. The Remote Participants 107 receive their real-time instruction and guidance from the Leader 101 as viewed and heard on Remote Computer 109 over the Internet 106 via the videoconferencing system. Note that the same room facility, participants and videoconferencing system are depicted in FIGS. 2 and 3; the yoga and storyboarding activities have been depicted separately in FIGS. 2 and 3 only for the sake of clarity and because the yoga and storyboarding exercises take place sequentially through time during a Balanced Group Thinking session and do not take place contemporaneously.

Subsequent to the conclusion of the initial Balanced Group Thinking session, participants may optionally communicate and share ideas and track the completion of their mutual action items via the Internet through commercially available group collaboration software such as IBM Lotus Domino that has been installed on all Local Computers 105 and Remote Computers 109 and 116. Storyboard information can be optionally captured visually and textually during and after the Balanced Group Thinking session using commercially available graphics software such as Microsoft PowerPoint® or Microsoft Visio®, which illustrations of storyboarding information generated by the group may be shared among local and remote participants in real time via one or more videoconferencing whiteboards.

FIG. 3—Storyboarding

Referring now to FIG. 3, the typical physical setup is depicted for a Balanced Group Thinking session, which typically lasts for eight hours during regular business hours at the participants' company facility or at a rented hotel conference room capable of providing the necessary Internet connections and computer and videoconferencing equipment. In front of the group is at least one easily readable large wall display or Storyboard 110, or computer screen projection display if the storyboard is automated on an electronic whiteboard using commercially available videoconferencing software such as Microsoft NetMeeting used in combination with graphic display software such as Microsoft PowerPoint or Microsoft Visio, upon which the group's ideas are transcribed and visually displayed as they are expressed during the storyboarding process. Typically, for clarity, one idea is expressed succinctly within each storyboard card or box.

One key to the utility of the storyboard is that the ideas displayed on it can be rearranged by the Storyboarding Leader 111, who may be the same person as the yoga exercise Leader 101. Sometimes the visual rearranging of ideas is done by the Storyboarding Leader's assistant and/or by one or more of the participants. Such rearranging is typically done to clarify the group's collective thinking process during the course of a storyboarding session, and may be mandated by the group or suggested by the Storyboarding Leader to improve the group's progress toward the objectives of the business planning Balanced Group Thinking session.

Particular types of storyboarding sessions are most appropriate for specific business planning purposes, such as strategic planning, problem solving, situation assessment, project management, team building, business process re-engineering, technology planning, Internet strategy, and electronic commerce development, and thus each particular type of storyboarding session can have a different standard format (see some examples in FIG. 6) that has proven useful for organizing ideas, alternatives, priorities, action items and other topical areas appropriate to business planning processes. The examples given within this description of the invention are drawn from typical problem solving storyboarding sessions.

The storyboard may be composed of a variety of physical materials, or may be an entirely electronic representation. A physical storyboard can have a felt or cork surface so that individual index cards may be affixed to it using push pins, or alternately, for example, a physical storyboard may be a sheet of blank flipchart paper taped to the wall of the group's room with masking tape so that individual Post-It Notes® sheets or similar device, such as those described in prior art, may be affixed to it using built-in adhesive backing. In short, any physical or electronic representation of a storyboard with moveable idea cards is sufficient so long as it is easily visible and readable by all participants local and remote.

The Storyboarding Leader 111 is responsible for making sure the group makes progress toward realizing the management objectives of the Balanced Group Thinking session. The Storyboarding Leader structures the storyboarding activities in sequence in advance based upon suggested standard format Storyboard Visual Instruction Aids 112 provided through this invention to achieve the desired objectives, or, in an alternate embodiment, based upon storyboard formats the Storyboarding Leader may have utilized in previous engagements. Each of the standard format Storyboard Visual Instruction Aids 112 provides the name of a main idea category under which to cluster the various idea cards that are generated by participants during the Balanced Group Thinking session, or the name of a business planning exercise under which the resulting idea cards are placed when generated by participants during an exercise. The Storyboarding Leader also performs other session planning activities as described in FIG. 4.

The Local Participants 103 are typically seated in the same room with the Storyboard 110 so that it is easily visible and readable to each participant. Local Computer 105 running commercially available software such as Microsoft NetMeeting is used to link the local participants with remote participating groups, if any, via the Internet 106 for real-time videoconferencing and interaction. The computer screen should be capable of displaying live video feeds from the remote sites during the storyboarding process to improve live feedback and interaction among all participants. Local Video Camera 104 sends a real-time video image and sound of the local participants to the remote participants via the Internet 106 as part of the videoconferencing system. Storyboard Video Camera 113 simultaneously sends a real-time video image of the changing Storyboard 110 to the remote participants via the Internet 106 as part of the videoconferencing system.

One or more groups of optionally Remote Participants 107 and 114 participate in the Balanced Group Thinking session via the Internet 106. Remote Computers 109 and 116 run commercially available software such as Microsoft NetMeeting to link the remote participants with other participating groups via the Internet 106 for real-time videoconferencing and interaction. At the time of this patent filing, Microsoft NetMeeting is included at no extra charge within every personal computer running the Windows 98, Windows ME or Windows 2000 operating system, thus potentially enabling videoconferencing via the Internet for tens of millions of personal computer users. Microsoft NetMeeting software features videoconferencing capability, multiple user-controlled electronic whiteboards, bidirectional audio and video transmission, and other advanced videoconferencing features. Each computer screen should be capable of displaying live video feeds from the other sites during the storyboarding process to improve live feedback and interaction among all participants. Remote Video Camera 108 sends a real-time video image and sound of the Remote Participants 107 to the other participants via the Internet 106 as part of the videoconferencing system. Remote Video Camera 115 simultaneously sends a real-time video image and sound of more Remote Participants 114 to the other participants via the Internet 106 as part of the videoconferencing system.

FIG. 4—Steps for Implementing a Balanced Group Thinking Session

Referring now to FIG. 4, the Leader should follow certain sequential procedures to implement a successful Balanced Group Thinking session.

Referring now to FIG. 4A, a typical storyboarding process begins with a group, herein called the Client, that contracts for the Balanced Group Thinking process 201 to be provided by a Balanced Group Thinking service provider, typically including at least one Leader to act as a facilitator and a yoga teacher. The yoga teacher Leader and the Storyboarding Leader may be the same person if sufficiently skilled in both arts. The Client provides information on the age and general health of the anticipated Participants 202 to the Leader so the appropriate yogic exercises can be selected 203 from among the possible yoga exercise alternatives. The Leader interviews the Sanctioner, a Client senior management executive, to determine the Client's objectives and desired outcomes from the Balanced Group Thinking session 204.

The Leader defines the storyboarding session fundamentals 205. The fundamentals consist of five key questions posed by the Leader and answered by the Sanctioner during the interview:

1. What type of business planning session is required?

Typical choices are: strategic planning, problem solving, situation assessment, project management, team building, business process re-engineering, technology planning, or Internet strategy development. Since each session type has different objectives, participants and focus, this information must be decided upon before the session can take place.

2. What is your overall position, point of view or belief about the session?

3. What are the characteristics of the participants: who they are, what are their interests and common bond, and what are their capabilities for performing yoga?

4. What actions do you want the participants to take?

5. What are the top three benefits to the participants if they take the desired actions?

The Leader then works with the Sanctioner to arrange for setup of the appropriate facility, site logistics, videoconferencing hookups and equipment 206 where the Balanced Group Thinking session will take place. The Sanctioner notifies all participants of the event date, address, agenda and what to wear 207. Referring now to FIG. 4B, the Leader inspects the facility and finalizes the room layout, logistics and meal menu 208.

The Leader pre-prepares selected storyboard cards for categorizing ideas based on Standard Formats (see FIG. 6) to keep the session focused on the fundamentals and the Sanctioner's objectives 209. The Leader reviews the Sanctioner's planned introductory speech 210. The Leader develops a detailed outline of planned storyboarding activities 211 and determines the approximate durations of each activity. The durations are totaled, and the estimated activity durations are then adjusted as necessary to fulfill the session objectives in the most expeditious and complete manner.

Referring now to FIG. 4C, finally the day of the Storyboarding event arrives 212. The Leader conducts a final check of all videoconferencing equipment, session materials and the attendee list 213. Participants assemble simultaneously in local and/or remote locations, connected to each other via the videoconferencing system. To begin the Balanced Group Thinking session, the Sanctioner presents a brief speech on the main purpose of the session and states the management objectives for the session 214.

Participants then each in turn introduce themselves to the group using storyboarding cards 215. To stimulate creative thinking, participants are typically encouraged to draw pictures on their card of selected aspects about their background, personality, occupation and hobbies, and each Participant then presents this information to the group. The Leader, or Leaders if different people act as facilitator and yoga teacher, introduces himself or herself to the group last.

Typically the first hour of each day of a Balanced Group Thinking session consists of yoga exercises designed to relax and energize the Participants, balance the hemispheres of their brains, and stimulate intuition and creativity. Referring now to FIG. 4D, to begin the yoga, the yoga teacher Leader invokes the guidance of his yoga teacher by chanting 216 “Ong Namo Guru Dev Namo” three times as illustrated in FIG. 5A. The yoga teacher Leader then leads up to one hour of yoga exercises 217 using the exercises illustrated in FIG. 5 or equivalent choices based upon knowledge of the art.

The Leader facilitates group discussion providing any input to and modification of session objectives 218. The Leader then conducts brainstorming group interaction on the main topic or session objective 219, such as the specific problem to be solved during a problem solving session.

Referring now to FIG. 4E, during the brainstorming interaction, each Participant's ideas are shared audibly and visibly with the group, and these shared ideas are transcribed and written legibly on cards, or Post-It Notes® or equivalent in the preferred embodiment of the invention, and immediately placed on one or more blank storyboards displayed in front of the local group and displayed to any remote groups by videoconferencing webcam video cameras 220.

Once all the ideas are shared and displayed, the Leader conducts group discussion and categorization of ideas generated 221, and idea cards are rearranged and clustered together visually based on similarity of ideas. Larger and/or different color cards are generated as header labels for each category and placed atop the clusters or collections of idea cards on the storyboards as appropriate; these category labels are generally not selected in advance, but are generated as a result of the brainstorming activity. The Leader and/or assistant then visually rearrange and regroup the idea cards below the appropriate category header cards. Ideas that fit into no particular category, or are not germane to the session objectives, are clustered together under the Miscellaneous category.

Once the ideas have all been categorized, the groups are invited to begin analysis and selection of solutions that may be favored by the each Participant 222. The detailed process for this step is as follows: Participants are given voting instructions and proceed to mark their favored ideas from among those previously brainstormed, using marker pens or colored sticky dots. Each Participant is given a specific number of votes, along with a voting rule that only one vote of their possible votes can be cast for any particular card. The Leader uses the following formula for calculating the maximum number of votes that may be cast by each Participant:

Voting Formula: the number of ideas generated divided by the number of Participants, rounded down to the nearest lower integer, plus one.

The group takes a short break while the Leader and assistant tally the voting results, and rearrange or copy the cards with the most votes under a new category Top Ideas, arranged in a column with winning cards listed in a column from top to bottom in descending order. Usually there are at least three cards with more votes than any others, and these are listed in the Top Ideas category along with the next most-voted runners up cards. The winning cards contain the ideas and their vote tally. If graphical presentation software such as Microsoft PowerPoint or Microsoft Visio is used, the winning Top Ideas cards are created within PowerPoint or Visio and displayed to the remote groups via the videoconferencing shared whiteboard. At the conclusion of the break, the Leader announces the voting results and facilitates group discussion, which occasionally results in redefinition and consolidation of the various Top Ideas, and the group seeks consensus and assigns priorities and urgencies to the revised Top Ideas.

At any time throughout the storyboarding process that the Leader notices that the group energy is waning or that group discussion appears to be obstructed by frustration, negative emotion or interpersonal arguments, additional brief yoga exercises of typically less than 10 minutes duration can be administered as needed to keep the group energy flowing 223.

Referring now to FIG. 4F, once the group has reached consensus on the priorities and Top Ideas to be implemented, the Leader leads the group in generating a series of agreed upon action items 224 to achieve the intended results. The action items are typically displayed in storyboard format for the group as a matrix with several columns entitled “Action Item”, “Category”, “Priority”, “Driver” and “Due Date”. Each action item is added to this visual matrix as another row in the table, as shown in the example below:

| | | | | Due |
|---|---|---|---|---|
| Action Item | Category | Priority | Driver | Date |
| Assemble a quick action team | Quick fixes | High | | Next |
| dedicated full-time for four | | | | Monday |
| weeks to focus exclusively on | | | | |
| solving customer problems | | | | |
| Send email to division | Field support | High | | End of |
| managers highlighting the | | | | this |
| problem and recommended | | | | week |
| solutions | | | | |

At this stage of generating action items, no assignments of responsibility are made in order to avoid suppressing an idea because of reluctance of Participants to take on responsibility for implementing that idea. Once the action item list is complete to the group's satisfaction, the Leader leads the group in reexamining the list from the top and assigning responsible parties, known as the “Driver,” to each action item.

The Leader then leads the group into determination of any communication and coordination activities 225 that may be necessary as a result of the storyboarding session and what has been learned and decided. These decisions can be visually displayed as another matrix, typically in a format such as the example below:

| What to | | | Due | |
|---|---|---|---|---|
| communicate | Priority | To whom | date | How |
| Detailed findings | High | Participants, | End | Email of a |
| of this story- | | Senior | of | Word document |
| boarding session | | Management | this | |
| | | | week | |
| New company | High | All divisional | End | Draft by sub- |
| policy on | | managers, all | of | committee of this |
| customer | | regional man- | this | session's |
| complaint | | agers, Customer | week | participants; |
| handling | | Service Center | | review by |
| | | managers | | Operations VP |
| | | | | before issuance |

As concluding activities, the Leader solicits storyboarding cards from Participants to provide feedback on the Balanced Group Thinking session 226, under the following categories: What went well; What needs improvement; and What to do next time. The group then discusses whether additional Balanced Group Thinking sessions are needed 227, and if so, a new session is scheduled.

The foregoing steps for implementing a Balanced Group Thinking session is an example of one of many possible embodiments of the invention. Accordingly, the scope of the invention should be determined not by the embodiments illustrated, but by the appended claims and their legal equivalents.

FIG. 5—Yoga Visual Instruction Aids

Referring now to FIG. 5, this yoga exercise technology stimulates each participant's nervous system, strengthens the nervous system, reduces stress, increases mental concentration, secretes the endocrine glandular system including pituitary gland and pineal body within the brain to elevate awareness, thus stimulating intuition and creativity. FIGS. 5A, 5B and 5C explain how to begin yoga exercise. FIGS. 5D, 5E and 5F illustrate a typical warm-up breathing exercise. FIGS. 5G, 5H and 5I illustrate a typical Balanced Group Thinking yoga exercise that can be performed while sitting in a chair or while sitting on the ground. These yogic exercises, embodied in laminated printed instruction sheets as Yoga Visual Instruction Aids 102 in FIG. 2 can be made available to Balanced Group Thinking leaders through the inventor or assignee, or, in an alternate embodiment, may be derived from experience by one skilled in the art.

Referring now to FIGS. 5J and 5K, this yoga exercise technology causes the two hemispheres of the brain to communicate and coordinate more effectively, develops endurance and calmness, strengthens the sympathetic and parasympathetic nervous systems, calms reactions to stress, and stimulates the pituitary gland to secrete to optimize mental clarity, intuition and decision making capacities. FIGS. 5L and 5M illustrate another typical Balanced Group Thinking exercise that stimulates the intuitive and creative part of the brain by stimulating the pituitary gland to secrete within the brain. FIGS. 5M and 5N illustrate another typical Balanced Group Thinking exercise that provides an experience of the human electromagnetic field. Finally, FIGS. 50, 5P and 5Q illustrate a typical relaxation that concludes a series of yoga exercises.

FIG. 6—Storyboard Visual Instruction Aids

FIG. 6 illustrates some of the specific standard formats for storyboarding processes typically taught to Balanced Group Thinking session participants, embodied in laminated printed instructions as Storyboard Visual Instruction Aids 112 for the use of the storyboarding leader. The standard formats provide typical header labels for display columns and clusters of idea cards that may be grouped together through common themes, ideas or concepts. Many other variations are possible; accordingly the scope of the invention should be determined not by the embodiment(s) illustrated, but by the appended claims and their legal equivalents. For example, the specific idea cards that may be generated by any given group in a particular storyboarding session cannot be anticipated and thus are cannot be anticipated in the standard formats. In another example, as a leader gains experience in the art, the leader may over time develop unique standard formats that also cannot be anticipated here.

FIG. 7—Example of a Storyboard in Process

FIG. 7 illustrates a typical storyboard mid-way through a Balanced Group Thinking storyboarding session; in this example the storyboard represented is a snapshot of a group 's ideas and discussion for solving a particular problem at the moment when this evolving discussion has not yet reached the stage when group can achieve consensus on the issues being considered.

FIG. 8—Examples of Yoga Visual Instruction Aids

FIG. 8 depicts in a series of 12 pages some examples of typical fully-formatted Yoga Visual Instruction Aids in the preferred embodiment of the invention as printed instruction sheets within clear plastic lamination. Each of the 12 pages of FIG. 8 is labeled on the back with a figure number from 8A to 8L.

FIGS. 8A and 8B explain how to begin yoga exercise. FIGS. 8C, 8D and 8E illustrate a typical warm-up breathing exercise. FIGS. 8F and 8G illustrate a typical Balanced Group Thinking yoga exercise that can be performed while sitting in a chair or while sitting on the ground. FIG. 8H illustrates a yoga exercise that causes the two hemispheres of the brain to communicate and coordinate more effectively, develops endurance and calmness, strengthens the sympathetic and parasympathetic nervous systems, calms reactions to stress, and stimulates the pituitary gland to secrete to optimize mental clarity, intuition and decision making capacities. FIG. 8I illustrates a yoga exercise that stimulates the intuitive and creative part of the brain by stimulating the pituitary gland to secrete within the brain. FIG. 8J illustrates a yoga exercise that provides an experience of the human electromagnetic field. Finally, FIGS. 8K and 8L illustrate a typical relaxation that concludes a series of yoga exercises.

The examples in FIG. 8 are only a small sampling of the many possible embodiments of the invention. Accordingly, the scope of the invention should be determined not by the embodiments illustrated, but by the appended claims and their legal equivalents.

Operation of the Invention—Alternative Embodiments

Alternative embodiments of Balanced Group Thinking as a means to implement effective business planning processes include using Kundalini Yoga exercises, as drawn from the 3HO Foundation archives of Kundalini Yoga as taught by Yogi Bhaj an, other than those depicted in FIG. 5 to improve participants' alertness, elevate energy level, stimulate the chakras, open the heart to compassion and empathy with others, reduce stress and increase mental receptivity to new ideas, balance participants' brain hemispheres for more effective decision making, expand the electromagnetic field, and stimulate intuition and creativity.

Alternative embodiments of Balanced Group Thinking as a means to implement effective business planning processes include using less complete forms of yoga than Kundalini Yoga as taught by Yogi Bhajan to improve participants' alertness, elevate energy level, stimulate the chakras, open the heart to compassion and empathy with others, reduce stress and increase mental receptivity to new ideas, expand the electromagnetic field, balance participants' brain hemispheres for more effective decision making, and stimulate intuition and creativity. Kundalini Yoga is considered by those knowledgeable in the art to be the “mother” of all yogas, subsuming all twenty-two known forms of yoga.

Alternative embodiments of Balanced Group Thinking include using Storyboard Visual Instruction Aids standard formats different than those depicted in FIG. 6 to conduct storyboarding for group decision making in strategic planning, problem solving, situation assessment, project management, team building, business process re-engineering, technology planning, Internet strategy, group meetings, and other business planning processes.

Alternative embodiments of Balanced Group Thinking omit the use of Internet-based videoconferencing systems to link local and remote participants in real-time interaction.

Alternative embodiments of Balanced Group Thinking omit the use of Internet-based group collaboration systems to facilitate ongoing communication and coordination between participants subsequent to the group Balanced Group Thinking sessions.

Alternate embodiments of Balanced Group Thinking exclude certain participants from performing yoga exercises, such as those who object for reasons of personal belief, disabled persons, and artificial intelligence agents.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims and their legal equivalents.

Conclusion, Ramifications, and Scope of Invention

The synergistic combination of yoga and storyboarding provides a method to practice more effective group creative thinking sessions, through the transformation of the brain functioning of participants and through the improved quality of their interaction, communication and sharing of ideas during storyboarding.

This invention has the power to revolutionize how all organizational planning processes are conducted, including, but not limited to, strategic planning, business process re-engineering, problem solving, project management, situation assessment, technology planning, value chain collaboration, international negotiation and conflict resolution, orientation and operational training, conducting business meetings, and many other organizational planning processes.

While the preceding description of the invention contains many specifications, these should not be construed as limitations on the scope of the invention, but rather as an exemplification of one preferred embodiment thereof. Many other variations are possible. For example:

various forms and styles of yoga may be practiced;

various activities for group interaction known to those skilled in the art may be practiced that have not been detailed here, such as, for example, alternate warmup exercises and activities to familiarize creative thinking session participants with each other;

various storyboarding activities for group interaction as described in FIG. 4 may be practiced in a different sequence;

other means for visibly and audibly connecting local and remote participants may be utilized that have not been invented yet;

other participants may join in creative thinking sessions and storyboarding activities that are not capable of performing yoga exercises, such as those who object for reasons of personal belief, disabled persons, and artificial intelligence agents.

Accordingly, the scope of the invention should be determined not by the embodiments illustrated, but by the appended claims and their legal equivalents.

What is claimed is:

1. A method for leading a group of people through a process for decision making by executing a plurality of creative thinking sessions, said method comprising:
selecting a leader or a plurality of leaders of said group to act in the capacity of a yoga teacher and a facilitator;
providing yoga and meditation exercise sufficient to adjust brain functioning of participants in said group; and
conducting storyboarding to communicate, share and analyze ideas among participants in said group; whereby the interaction and decision making effectiveness of said group is improved.

2. A method as in claim 1 further comprising:
providing an environment for said group to generate and select ideas for making a decision, solving a problem, planning a strategy, managing a project, assessing a situation, conducting a meeting, and resolving other difficulties challenging to said group;
said environment including audio and visual information relating to yoga exercise and storyboarding; and
providing a means to record and play back said generated and selected ideas.

3. A method as in claim 2 wherein a plurality of yoga exercise instructions are audibly and visibly conveyed to said group.

4. A method as in claim 3 wherein, in the preferred embodiment, participants in said group who are present remotely are connected by means of a computerized Internet videoconferencing system,
further providing a feedback loop through which said participants' performance of said yoga exercises can be monitored and corrected as necessary.

5. A method as in claim 3 wherein a plurality of appropriate yoga exercises are selected, in the preferred embodiment, for:
increasing fullness and duration of breathing;
relieving physical, mental and emotional stress;
strengthening nerves and body;
adjusting brain functioning of participants in said group;
improving mental concentration;
balancing left and right hemispheres of the brain;
increasing endocrine glandular secretions including pituitary gland as the seat of intuition;
elevating mood;
strengthening human electromagnetic fields for greater group harmony, cooperation and cohesion; and
stimulating autoimmune system for improved health;
wherein said yoga exercises are used to improve group decision making.

6. A method as in claim 5 wherein said yoga exercise instructions are Kundalini Yoga and meditation exercises as taught by Yogi Bhaj an, and archived for posterity by 3HO Foundation.

7. A method as in claim 2 wherein each of the ideas of said group as they are expressed aloud are transcribed and visually displayed on moveable cards on a storyboard visible to all participants in said group.

8. A method as in claim 7 wherein said moveable cards are constructed, in the preferred embodiment, of removable paper slips with pressure-sensitive adhesive backing mounted on said storyboard.

9. A method as in claim 7 wherein said moveable cards are arranged and organized in accordance with the wishes of said group and, in the preferred embodiment, in accordance with prerecorded moveable cards containing storyboard header titles as designed by said leader.

10. A method as in claim 7 wherein, in the preferred embodiment, participants in said group who are present remotely are connected by means of said computerized Internet videoconferencing system
wherein information on said moveable cards is captured and displayed for said remote participants by means of a computerized whiteboard, wherein said whiteboard is implemented within said computerized Internet videoconferencing system.

11. A method as in claim 1 further comprising
providing said leader with means for determining in advance the objectives, expected participants, desired yoga exercise results and desired outcomes of said creative thinking sessions.

12. Visual instruction aids for leading a group of people through a process for decision making by executing a plurality of creative thinking sessions, comprising:
yoga and meditation exercise instructions printed on paper and laminated in durable clear plastic, and
standard formats of storyboard layouts with preprinted header information printed on paper and laminated in durable clear plastic.

13. Said visual instruction aids of claim 12 further comprising yoga and meditation exercise instructions printed on paper and laminated in durable clear plastic, which are used for:
increasing fullness and duration of breathing;
relieving physical, mental and emotional stress;
strengthening nerves and body;
adjusting brain functioning of participants in said group;
improving mental concentration;
balancing left and right hemispheres of the brain;
increasing endocrine glandular secretions including pituitary gland as the seat of intuition;
elevating mood;
strengthening human electromagnetic fields for greater group harmony, cooperation and cohesion; and
stimulating autoimmune system for improved health;
wherein said visual instruction aids enable an improvement in group decision making.

14. Said visual instruction aids of claim 13 further comprising Kundalini Yoga and meditation as taught by Yogi Bhajan, and archived for posterity by 3HO Foundation.

15. Said visual instruction aids of claim 12 further comprising standard formats of storyboard layouts with preprinted header information printed on paper and laminated in durable clear plastic, for:
making a decision;
solving a problem;
planning a strategy;
managing a project;
assessing a situation;
conducting a meeting; and
resolving other difficulties challenging to said group
whereby the interaction and decision making of said group is improved.
